(19) United States
(12) Patent Application Publication
(10) Pub. No.: US 2002/0016731 A1
(43) Pub. Date: Feb. 7, 2002

(54) Method and system for internet sampling

(76) Inventor: Benjamin Kupersmit, Denver, CO (US)

Correspondence Address: Joseph E. Kovarik, Esq., SHERIDAN ROSS P.C., 1560 Broadway, Suite 1200, Denver, CO, 80202-5141, US

(21) Appl. No.: 09/865,956

(22) Filed: May 25, 2001

Related U.S. Application Data
(60) Provisional application No. 60/207,712, filed on May 26, 2000.

(51) Int. Cl. G06F 17/60

(52) U.S. Cl. 705/10

(57) ABSTRACT

A method and system for the sampling, or scientific collection of random, representative data, from a population of individuals when the primary method of gathering the responses to a given survey comprising a set of questions contained in a questionnaire with the purpose of identifying the attitudes of the given population is over the Internet.

### FIELD OF THE INVENTION

The present invention is directed to a method for performing Internet surveys, and in particular, is directed to a method whereby a representative set of respondents is derived, such respondents are contacted, responses from such respondents are collected and probability sampling methods are employed to complete the results of such survey.

### BACKGROUND OF THE INVENTION

Customers of today's market research firms regularly utilize opinion surveys to make strategic decisions. More specifically, answers to survey questions are scientifically gathered from a set of individuals who are chosen in such a way that their responses represent the views of a desired target audience. By analyzing these responses, survey research companies provide their customers with insights regarding the attitudes and characteristics of the target audience in question.

The key to this type of market research is that, in a scientific survey, a set of responses is gathered from a subset of the target audience which is selected in a systematic way. This process of selection, known as “random sampling,” ensures that the data can be used reliably and can be considered quantitative, statistically representative data.

Specifically, industry criteria regarding random sampling require that: “Sampling should be designed to guard against unplanned selectiveness. A survey's intent is not to describe the particular individuals who, by chance, are part of the sample, but rather to obtain a composite profile of the population. In a bona fide survey, the sample is not selected haphazardly or only from persons who volunteer to participate. It is scientifically chosen so that each person in a population will have a measurable chance of selection.” Source: American Association of Public Opinion Research (AAPOR); Best Practices for Survey and Public Opinion Research. Further explanation of random sampling can be found in the Definition of Terms below.

There are other types of research—qualitative methodologies—which do not purport or seek to claim scientific accuracy, including focus groups, mall intercept studies and others. But survey research—a quantitative methodology—must be grounded in the principles outlined above in order to claim accuracy in representing the views of the given population. Namely, a survey must be conducted in such a way that the individuals who respond to the questions are selected using principles of random sampling, and not through approaches which either 1) draw their responses from individuals that are not wholly representative of the target audience, and/or 2) draw their responses only from volunteers or “self-selected” members of the target audience.

The process of random sampling is brought to bear, and therefore accuracy and reliability are claimed, when surveys are conducted over the telephone. First, a list of phone numbers that is representative of the population known as the “sample” is identified. The people whose numbers are in the sample are then contacted systematically, with principles of random sampling guiding the recruitment of actual respondents to the survey. This approach is effective in creating scientific sets of data which achieve the requirements laid out in the AAPOR criteria outlined above. The reason for this is that everyone has a phone, and therefore, anyone can be theoretically invited to participate in a survey, and therefore, random sampling can be utilized to select both the sample from the population and the respondents to the survey from the sample.

For today's market research companies, the availability and reliability of phone numbers means that surveys can be conducted among both very broad and very narrow targets with great accuracy. In many situations, samples can be identified (with phone lists provided by clients or purchased from a list broker) that directly represent the population in question. If not, samples called “Random Digit Dial” samples (RDD) are readily available from the phone company, where lists of phone numbers generated by a computer (specific to certain geographic areas) are used to call into a target area and screen for respondents to the survey. A key advantage of RDD is that unlisted phone numbers can be captured as well (because the phone numbers are generated through a random number generator which creates random sets of digits, including live, dead, and unlisted numbers).

Once the phone numbers have been identified and a sample has been generated, telemarketers dial the phone numbers, screen for the appropriate individuals (over 18, frequent travelers, voters, etc.) and ask the questions to the survey over the phone. The telemarketer (or interviewer) is typically seated at a computer terminal in a phone bank or call center wearing a headset with telephonic capabilities. They are given phone numbers to call, and the script of questions to be read, over the terminal. They record the responses to the survey to the terminal through keystroke inputs, where the data (alpha or numeric) is written to a database that is then accessible for analysis by the market researchers and analysts.

This system has proven effective—and is the industry standard for quantitative research because it relies on telephone numbers to generate the samples and recruit the individuals to the surveys. Telephone numbers are critical, because everyone in the population has them. Telephone calls are critical, because the researcher controls the selection of the actual individuals who are invited to participate in the research.

The current methods used to recruit individuals to respond to surveys in which data is collected over the Internet are based on individuals responding to a survey that they are recruited to in ways that fall short of the standard set by telephone surveys. The following criteria are not met by the approaches to Internet sampling and recruiting which are used today:

1. That the data be gathered from a set of individuals that does not volunteer themselves or control the decision of being included in the sample. Violation of this criteria is known as “self-selection.”

2. That the research give every member of the population a chance to be included. Violation of this criteria is termed “non-response bias.” In the case of the Internet, two specific types of non-response bias are particularly problematic in creating scientific samples of Internet users:

2a. Individuals who have concerns about privacy on the Internet, and therefore do not typically give out their e-mail addresses, are omitted by today's methods.

2b. Individuals who have low technology or low levels of usage regarding the Internet are similarly left out.

Criteria #1, known in the industry as the phenomenon of “self-selection,” is violated when individuals are not selected by the researcher, but rather when a broad stroke is attempted to include individuals, and the individuals themselves decide whether or not to participate in the study. If the researcher does not control the selection process, only those individuals who are inclined to respond to the survey (because they have strong views, typically) do so.

Regarding criteria #2, every member of a population must have a chance of being included in the research. Violations of this criteria result in non-response bias, and the data (and conclusions drawn from the data) are typically flawed. This problem is exacerbated in cases where all of the individuals who are omitted from the research share a trait or quality that is critical to the nature of the research in question.

There are currently several basic methods used currently to recruit individuals to participate in online or Internet surveys. The first of these is that respondents who are already surfing a website respond to a “mouse-click” banner advertisement that links them to a survey web page or downloads an executable program which presents the survey to the respondent. Because the individual has full control as to whether to respond to these “pop-up” invitations or banner advertisements, the first criteria outlined above is not met.

The second method used for Internet surveys is through the recruitment of individuals to panels (a set of individuals which has been pre-selected and has agreed to regularly respond to surveys), and then sending them e-mail invitations to visit a particular website where they respond to a survey. In order to create panels, various techniques are used. The first technique used to recruit individuals to join panels is through the placement of banner advertising or other types of “hit” opportunities where Internet clients can volunteer to join the panel. This violates the conditions for scientifically accurate research regarding self-selection, just like the “pop-up” or banner invitations described above. Like any “mail survey,” e-mail surveys also tend to garner responses from the extreme points of view; individuals who care enough to answer will be those included in the sample.

The second technique for recruiting individuals to panels relies on invitations delivered to an Internet client's e-mail address. Laws against “spamming” of individuals (the unsolicited delivery of an e-mail message to an Internet client) create a barrier to the creation of scientific samples for a survey through this method. This is because any individual invited to join a panel must have first given permission to receive e-mails and such individuals (who join a panel because they received an e-mail invitation) by definition have already selected whether or not to receive an e-mail from the market research firm, thus violating the criteria concerning self-selection and non-response bias. In addition, e-mail lists are proving to be unreliable as valid identifiers of a specific individual because many people have multiple e-mails or do not open email that they consider to be junk mail.

The creation of panels through e-mail solicitation thus violates criteria #2 above, namely, it excludes individuals with a pre-disposition not to give out their e-mail address, members of target population customers who cannot be contacted in order to solicit their e-mail address and individuals who are less likely to answer e-mail and regularly fill out survey research (often requiring personal information) due to privacy concerns.

One corporation (InterSurvey Corporation) recruits individuals to their Internet panel using scientific techniques based in telephonic sampling techniques. The panels this company recruits can be said to represent the general population, as per their claim on their website (www.InterSurvey.com). However, the method used for inviting individuals to participate in an actual survey from one of these panels is by sending e-mails to the panel members who meet a set of predetermined criterion for representing a given population. Thus, the panel members choose themselves whether to participate in the individual survey or not. This violates the criterion for self-selection common to any e-mail invitation or situation when a broad invitation is sent to a group, and then the members of the group who are so disposed participate in the survey.

Furthermore, InterSurvey gives participants advanced computer systems (known as WebTV systems) for accessing and using the Internet. Because of this, InterSurvey violates criteria #2b above in that they omit people not having access to the levels of technology available to WebTV users. Thus, in conducting research into Internet related topics (website evaluations, web branding strategies, etc.), the responses are gathered from an audience that is uniformly utilizing advanced connection speeds and browsers (e.g. from the WebTV capabilities) which do not accurately reflect Internet usage patterns (where many people do not have high speed capabilities).

Another response bias facing InterSurvey or any panel based Internet survey research is that when respondents answer surveys regularly on the Internet, they become sophisticated at both using the Internet and answering surveys; again, such individuals do not represent those who are less sophisticated with Internet technology, but nonetheless are part of any market research into user Internet experiences.

Another method which is inadequate for ensuring scientific validity and representation of a population through online survey research is that of a “push” call wherein a set of e-mails is sent out to a group or a pre-selected panel and a phone call is then made encouraging participation in the survey. This method does not satisfy the criterion that a systematic and carefully controlled process be utilized to invite the “best-fit” sample members to a survey. Instead, it merely adds another level of incentive for the already self-selected audience to participate. In the end, simply making phone calls to a large number of people is not scientific research, just as “Get out the Vote” calls are not considered representative polls by political pollsters.

Corporations that conduct scientific research utilizing the telephone to conduct surveys are not hampered by these limitations in identifying and surveying a given audience. The telephone number is an identifier which is typically unique to a given household or place of business, and all households and business have a telephone. Additionally, phone numbers can easily be identified either through pre-purchased lists or through randomized sets of telephone numbers based on geographic areas (RDD, or Random Digit Dialing). Because all members of a population can be included, non-response issues are avoided. Because telephone calls can be made by the researcher (and the individuals who are called are selected systematically according to random sampling principles), self-selection is avoided. Systems for sampling and recruiting ensure that representative, desired sample members—and not just those who choose to participate in the research—are selected for the study using random sampling techniques.

However, the telephone is inadequate when compared to the Internet because it is unable to include visual or interactive materials in the testing, and is limited to a questionnaire script which can be read by a phone interviewer to the respondent. With the Internet, respondents are also able to answer surveys at their convenience and are not required to do so at the time of the phone call.

It is therefore desirable to create a method and system which meets the industry criteria for random sampling outlined above in regard to Internet survey research. It is desirable to provide customers of market research with a means of gathering responses to online surveys that are as accurate and representative as telephone based surveys. It is desirable to provide customers of market researchers with a system for including hard to reach individuals, including those concerned with privacy, those with low levels of sophistication regarding Internet technology, and others who are omitted through current online survey methods, in their research. It is also desirable to provide a system for utilizing existing phone lists and phone based techniques to reach audiences so researchers do not have to rely on e-mail lists for web surveys. It is also desirable to provide customers of telephone based survey research with an additional ability to include rich media (visual and audio components) in their testing and research. It is also desirable to provide a system for market researchers and customers to access the results of the surveys on the Internet in a timely and efficient manner.

### DEFINITION OF TERMS

The following definition of terms is provided for guidance of one of skill in the art when reviewing the description of the present invention.

Random Sampling:

The creation of a representative subset (also denoted “sample”) of a population which is used to select the respondents for surveys. A sample may be derived from a population using an “nth select,” where every “nth” member of the population is selected for the sample.

For example, using random sampling techniques, a sample for a survey of 100 individuals from a population of 10,000 is derived as follows:

1. The 10,000 members may be given a number from 1-10,000.

2. An arbitrary number is selected (e.g., 4,555).

3. Every 1,000^{th} member is selected in a first “pass.” These 100 people (corresponding to numbers 4,555, 4,655, 4,755, etc.) are considered the “best-fit” for the survey because they are the first selected population members. Each of these members is considered a “sample point,” because completion of the survey with just these 100 people would be a perfectly selected random sample.

4. One or more additional passes are made to provide “next-best” members at each sample point; so that if the member corresponding to the number 4,555 could not participate, member 4,556 is invited to participate. Depending on the situation, 10 to 20 passes might be made, with numbers 4,557, 4,558 . . . 4,565 being chosen to fill the “sample point” for member numbered 4,555.

Note that the identification of an individual sample point and the generation of member numbers through additional passes selecting members from a population is referred to in the present invention as creating a “cluster” of numbers for a sample point.

5. A list is obtained, with 100 sample points, and 10 to 20 member numbers in each sample point.

Note that sample generated from the population of 10,000 people, therefore, is made up of between 1,000-2,000 members segmented into 100 clusters. Each cluster contains 10 to 20 members in the order they were selected from the population.

6. This sample of 1,000-2,000 members is called systematically to recruit the 100 individuals who ultimately take the survey. At every stage, the highest positioned member (earliest pass made in the cluster) is actively recruited (i.e., the member having number 4,555 first, then, and only if 4,555 cannot participate, will member having number 4,556 be called) for the survey. If this condition is not met, the sampling frame has been violated. This process ensures that both criteria for scientific probability sampling—that all members of a population can be included, and that members do not “self-select”—are met.

Survey:

A process for collecting responses to a set of questions from a subset of a population in a way that the answers reflect the views of the entire population.

Population:

A target audience for research. The audience can be any range of individuals, from “all computer users” to “frequent travelers to South America.”

Sample:

The list of members of a population which is used for recruiting the individuals to take a survey.

Sample Member:

An individual member of a population which has been selected for a sample. In one embodiment of the present invention, sample members correspond to a unique phone number identifying a business or household. Sample members are referred to below with an “A”, wherein the A is the members' position in the cluster (as determined by the pass in which they were selected to the sample). The total number of sample members in each cluster is designated as “Y”, wherein the Y is the total number of passes made through the population.

Clusters:

A cluster is a group of sample members for a sample point, wherein the members identified in the first pass of an nth select are the first member in each cluster. These are identified throughout the document as cluster “N”, with the total number of clusters desired for a complete survey equal to “X”. For example, a survey with X=100 requires 100 clusters, and the 30^{th} cluster in that sample is cluster N=30. Each cluster has Y sample members.

### SUMMARY OF THE INVENTION

Current methods of Internet sampling are not capable of achieving the level of scientific accuracy approaching that obtained with telephone sampling. However, the present invention is capable of achieving such levels. Moreover, the present invention may be used for market research, public opinion research, political research, social sciences research, advertising and market testing, product testing, concept testing or any other form of questioning utilizing Internet based technologies when the purpose of the questioning is to accomplish a scientific and representative survey among a population of Internet clients by linking an online data collection system or apparatus with a telephone based sampling and recruitment system or apparatus.

The present invention creates a system for creating a random sample, recruiting respondents, gathering responses and generating a set of data from an Internet based survey. The present invention generates a random representative sample for survey research which meets accepted scientific AAPOR (American Association of Public Opinion Research) standards conducted via the Internet (more generally, an interactive audio/video communications network) as the primary medium for gathering survey data.

The present invention includes an apparatus for recruiting the individuals for surveying on the Internet through telephonic sampling systems and an apparatus for gathering data online through a website. The invention includes a number of background processes, directed actions, automated responses resulting from inputs and status checks across systems and apparatuses, and ongoing reporting and monitoring of these apparatuses to ensure a seamless connection between telephone based sampling and recruitment and the Internet based surveying. The invention creates scientifically accurate Internet samples by ensuring:

a) that a sample is derived from a population using random sampling techniques;

b) that individuals are selected from the sample for the survey in a systematic way that meets random sampling criteria;

c) that individuals who are selected for the survey are invited by telephone to visit a website and do a survey;

d) that the status of individuals who agree to take a survey on the Internet are monitored through a system of background processes and status checks;

e) that individuals are called with reminder messages automatically to ensure that those who agree to take a survey do so;

f) that individuals selected from the sample to participate, but do not take a survey, are replaced in a systematic way to ensure scientific sampling criterion are being met;

g) that the responses from the individuals who take the survey are gathered on the Internet at an online survey website;

h) that the data from the survey website is output in a file format which is easily accessed by users of the present invention.

As one skilled in the art will understand, the invention includes a system for integrating offline recruiting and online data collection, wherein a telephonic sampling and calling apparatus and system is integrated with an online data collection apparatus and system wherein all systems are linked together by the present invention to ensure seamless reporting and monitoring between the necessary apparatuses described herein.

One aspect of the present invention is the apparatus denoted herein as the sample control module. This component links and monitors the various systems and apparatuses necessary for the invention. Such apparatuses and systems include: telephonic equipment, computer servers, terminals for interviewing, computer code (Cold Fusion, Java, HTML), specified databases and other components which are noted below in the Detailed Description.

The functionalities which are accomplished through the various apparatuses, systems or databases which the present invention seamlessly integrates include:

a) creating a sample database having identifications of members of samples, wherein samples may be derived through an “nth select,” which is a process for systematically creating a sample by choosing specific individuals from a given population or target audience according to accepted random sampling methods;

b) the systematic selecting of sample members for invitation to the survey in a manner that maintains random sampling methods;

c) the contacting of these specified members of the sample database for recruitment by a telephone interviewer;

d) the reading of recruitment scripts to sample members from a computer aided terminal interviewing or Internet based interviewing terminal system;

e) the recording of answers to questions in these recruitment scripts including a unique password for entry to an online survey website for the respondent;

f) maintaining the log in status of each sample member and their corresponding password for responding to the online survey hosted on the website in a given time frame;

g) the generating of any necessary e-mails, call-backs or online-breakoff calls to ensure that scientifically selected sample members respond to the online survey;

h) the generating of the World Wide Web pages and web site for the collection of the data through visual questioning techniques, including the ability to show rich media; and

i) the completing of a survey by the desired sample members until a complete database of results has been produced which contains responses statistically representative of the given population.

The functions described above are linked together by the sample control module to ensure constant monitoring and reporting between the sampling and recruiting systems and the Internet based survey gathering website. Specifically, at least some of these functions can be executed through various combinations of software packages and pre-purchased systems, as will be noted below. They can be administered through either a local area network (LAN) or through the Internet as well. Thus, the present invention includes corresponding functions to ensure that telephonic sampling, and its advantages, are brought to bear in creating representative Internet samples.

One aspect of the present invention is directed to the generation of a random sample from a total list of, or a representation of, the population where every member of the population has an equal chance of inclusion in the sample. Each member of the population has a chance of inclusion because an “nth select” random sampling process is used to choose sample members. An “nth select” is a technique common in statistical sampling which entails taking a list of all the members in a population and, starting at an arbitrary point, choosing every “4^{th}” or “5^{th}” person for selection in the sample. Thus, if we were to take a population of 1,000 individuals, and seek to select 100 for a survey, we would begin by starting at an arbitrary place (person number 543, for example) and then choosing every 10^{th} person (544, 554, 564, etc.).

An aspect of the present invention is the use of telephone numbers in order to best represent populations for the creation of such random samples for use in online research. Because of RDD and list sampling opportunities, and because people have phones in their homes and place of business which do not change regularly, phone numbers are the best identifier of individuals available at this time.

Another aspect of the present invention is that sample members which were chosen from the population in the “nth select” are systematically selected for invitation to the online survey based on their ranking in the initial “nth select.” Because not every individual takes the survey, more than one person is typically needed to get a complete interview. In the example given above, one would need to choose sufficient individuals to ensure that 100 surveys were obtained. These cannot be arbitrary individuals, but must be the next individual in the point initially chosen in the first pass through the data when numbers were chosen in the “nth select.” In this example, if person 544 was unable to do the survey for whatever reason, the system ensures that person 545—and not person 333 or whoever—actually takes that survey.

Another aspect of the present invention is that the sample members which are invited to take a survey are invited using telephonic based interviewing, including computer aided terminal interviewing (CATI) or Internet based interviewing terminal (IBIT) techniques. The phone number of the desired sample member is passed from the sampling system to the recruiting system. The number is dialed, either manually or automatically, and a telemarketer or interviewer reads a pre-screening script to the sample member. If the sample member qualifies, and decides to do a survey, they are provided with a unique ID and password for entering the website and completing the survey. The anonymity and confidentiality of respondents is maintained.

Yet another aspect of the present invention is that call-backs are automatically generated which remind persons who have been invited to do so to visit the website and complete the survey. Also, online-breakoff calls are automatically generated which provide for a phone call to a respondent that begins to answer questions to an Internet survey and logs off before completing the survey. Also, the provision should be noted that an individual returning to a survey where they had logged off before completion begins at the point where they left off, and all previous data is valid still. Also the provision should be noted that an automatic e-mail is sent to consenting individuals to provide a direct link to the website which is hosting the online survey.

Another aspect of the present invention is the creation of a system providing for Internet based interviewing terminals (IBIT) in which a telemarketer or recruiter is provided with scripts for making phone calls to designated individuals. The corresponding display which is used for these phone calls and interviews is viewed and input is provided through a website on the Internet, and not on a local area network (as in the case of CATI systems). This allows users of this aspect of the present invention to access a “virtual call center,” wherein the administrators and supervisors set up all the functions of a phone calling operation (scripts, employee records, databases, etc.) and employees (telemarketers, interviewers, recruiters) access the phone numbers to be dialed and the scripts to be read over the Internet in their home or wherever they can access the web.

Note that the IBIT includes: a) the monitoring of employee/recruiter functions (including employee records, performance statistics, log-in information, security clearance, etc.); b) script setup and maintenance; c) the selection of telephone numbers; d) the provision of a website for employees to log in and view the necessary scripts and information for making the appropriate calls; and e) the databases necessary for recording the required information and reporting on the data and all other aspects of phone call interviewing which is controlled and accessed through a website and not a local area network. The IBIT also includes the ability to have one telephony or data line carry both the voice data for the phone call and the Internet based computer data which is necessary for the recruitment website. In other words, a recruiter is able to log in and see a screen that had instructions for a recruitment script (and any other scripts), and activate within the same page a contact to the household or business being contacted, and speak to a person using the same communication line (fiber optic, telephonic, etc.) as is used for the Internet connection. This allows for the elimination of physical or centralized phone bank centers and allows telemarketers and others when making outbound phone calls from a script presentation and recording the response to questions to work from any location where they have Internet access.

In a further aspect of the present invention, a website for conducting online surveys is provided. The website allows individuals who have been invited to complete a survey (e.g., individuals who were 1) in the population, were 2) selected for the sample, and were then 3) invited to participate) to do so. The website provides pages with questions allowing for open and close ended questioning. The surveys on the website gather responses to a set of questions in a form that can be accessed for analysis and presentation of strategic recommendations regarding concepts or materials. Concepts or materials that may be shown on the website include but are not limited to websites, audio, video, print or software programs.

Another aspect of the present invention is directed to a method for generating the continuous data responses to a question posed on the Internet which takes advantage of the Internet's graphic capabilities and mouse-click response recording capabilities to allow respondents to a survey to answer a question by clicking on a graphic line, and not by choosing a radio button or otherwise being limited to answer choices such as “strongly agree, somewhat agree, somewhat disagree, strongly disagree.”

Yet another aspect of the present invention relates to a method for generating continuous data responses to a question that is asked regarding a presentation such as a video or otherwise animated image. The image is shown, and concurrently, a graphic interface (a slider bar, for example) is displayed to a respondent. The respondent is presented with a graphical interface featuring a midpoint equal to the neutral or midpoint emotion or value being queried, with the left and right then designated as changes in this emotion or value (such as “agreement,” “belief,” “likeability,” etc.). Respondents are then asked to put their mouse or other mode of responding to the presentation on the neutral or midpoint of the graphical interface, and then asked to move to the left or the right, or to use their keyboard, to indicate changing reaction to the presentation as it is being shown. Simultaneously, a continuous value is being recorded of the respondent's input (e.g., 0 is output for the neutral point) and positive and negative values indicating a change and/or a rate of change of the respondent's opinions of the presentation as it is being shown and the respondent concurrently moves the slider bar. Such responses can be aggregated across many respondents to form a scientific sampling and representation of real-time reactions to time-elapsing video or other material.

Accordingly, the present invention provides the following aspects:

(1.) A method for performing an internet survey comprising:

(a) deriving a scientifically representative set of respondents from a scientifically derived sample;

(b) contacting said respondents;

(c) collecting responses from said respondents on a website wherein said respondents complete a survey on the website; and

(d) using telephone phone probability sampling as per AAPOR standards to sample and recruit said survey.

(2.) An additional limitation to (1) immediately above, wherein a sample control module is used to operate as a link between the Internet web servers and telephonic technology to ensure that scientific sampling standards are being achieved.

(3.) An additional limitation to (1) immediately above, wherein an Internet-based dialer dials a phone number from a given database of telephone numbers, dials the phone number over the Internet instead of through phone lines, establishes an initial call disposition, and connects live persons who answer the Internet generated phone call with a telemarketer or telephone survey interviewer.

(4.) An additional limitation to (1) immediately above, wherein said step of collecting data on the Internet comprises providing a graphic interface which appears on said website for the purposes of collecting the responses of individuals to questions requiring answers selected from at least two response choices: do you a) strongly agree, b) somewhat agree, c) somewhat disagree, and d) strongly disagree; said answers expressed in a continuous set of numerical values;

presenting a question to the respondent with said response choices presented spaced along a continuous line with markers indicating said response choices along the line at evenly spaced points;

having respondents utilize a mouse-click or keyboard stroke to indicate their individual response to the question on said line at whatever point they choose (not limited to just the whole values of 1=strongly, 2=somewhat) to register a recorded value expandable to any number of digits.

(5.) An additional limitation to (1) immediately above, wherein the various modules and systems are integrated into a set of code and databases or are otherwise combined to accomplish the same functionalities of the present invention, namely the controlled selection of respondents to an online survey through sampling of phone numbers, telephone recruiting and screening, website status checks and online data collection, with either the Internet or a client server or local area network serving as the conduit for the necessary communications between the systems for the sampling, recruiting, data collection and other functions of the present invention.

(6.) An additional limitation to (1) immediately above, wherein the recruiting and outbound or inbound phone calling of the present invention is conducted through an Internet based interviewing terminal system is created over the World Wide Web in which supervisors and administrators can set up and maintain sampling and recruiting and script and database and any other functions involved in outbound or inbound calling over the Internet; with employees or recruiters or interviewers or others who make the phone calls for such calling also accessing all functions necessary for the recruiting functionalities over the Internet, including logging in to work, having a phone number dialed and being given a script and questions to be read to an individual, and the recording of the responses from that individual, and thus allowing any individual with an Internet terminal to conduct an interview and gather data provided they have Internet access, and no longer requiring local area network or client server based applications.

7. An additional limitation to (6) immediately above wherein one communications line is used for both the data line transmitting the data over the Internet being used in the Terminal interviewing system noted above and also is used for the Voice data which is transmitted for the phone call conversation, allowing a recruiter to work at a computer station with a headset and have a phone call placed over the Internet to a pre-selected individual without needing a phone line separate from the computer.

Additional benefits and aspects of the present invention will become evident from the accompanying drawings and Detailed Description herein.

### BRIEF DESCRIPTION OF DRAWINGS

FIG. 1 is a block diagram displaying the components making up the present invention.

FIG. 2 is a block diagram of the components necessary to accomplish the sampling and recruiting for the present invention.

FIG. 3 is a block diagram of the website for accomplishing the collection of data for surveys.

FIG. 4 is a flowchart for the processes performed to accomplish the sampling and recruiting for the present invention.

FIG. 5 is a flowchart for the processes involved in the collection of data on the website.

FIG. 6 is a diagram of the structure of the website for any client node who visits the IP address for the website.

FIG. 7 is a diagram of question types for the survey question web pages of the present invention.

FIG. 8 is a block diagram of an alternative embodiment of the invention for contacting potential respondents wherein an Internet to phone dialer server is used, and wherein one communication line is utilized for both the presentation of recruitment information and for speaking to a potential respondent.

FIG. 9 is a block diagram of an alternative embodiment of the invention when the interviewing is done through an Internet based interviewing terminal (IBIT) and not through a computer aided terminal interviewing (CATI) system.

### DETAILED DESCRIPTION OF THE INVENTION

The present invention is a method and system for 1) scientifically sampling and recruiting, and 2) collecting data for an online survey of X interviews among a target population of Internet clients for the evaluation of a questionnaire Q including questions q, responses r, and materials m.

The sampling and recruiting techniques and corresponding systems are for: (i) the derivation of a sample from a population, (ii) the selection of sample members to be invited to a survey based on systematic selection of the “best-fit” sample members, (iii) the placing of specified phone calls by a telemarketer to the selected sample members, and (iv) the recording of responses by the interviewer regarding the disposition and status of the selected sample members regarding taking a survey at a website. The methods and apparatuses described herein which relate to collecting data for an online survey include the creation of a website which allows the sample members who agree to take an online survey to do so. Moreover, the website provides for a log-in web page requiring a unique password for entry, as well as pages where respondents can view materials and answer questions.

The present invention comprises a system, which includes necessary code, databases and apparatuses, for creating linkages and integration between sampling and recruiting systems and systems which relate to the collection of online survey data. This integration is a novel aspect of the invention thereby assuring that the sampling criteria for random sampling are met by interviews where the data is primarily gathered over the Internet.

The sample control module (210 in the accompanying Figures) of the present invention creates an integrated system which provides for: (i) generating a sample database (21); (ii) contacting members of that sample database in a discreet and controlled manner to ensure sampling practices which meet accepted polling industry standards; (iii) monitoring to ensure that contacted members who qualify and are invited to complete a survey on a website to do so; (iv) automating the calling of members providing for reminder calls and for calls to respondents who do not complete a survey to ensure that the desired sample members complete surveys and the sampling frame is accurately followed; (v) collecting responses to questionnaires over the Internet from respondents; (vi) creating evaluations of written, video and audio materials over the Internet; (vii) producing a survey results database of the survey for detailed analysis; and (viii) providing access to analyses of the results.

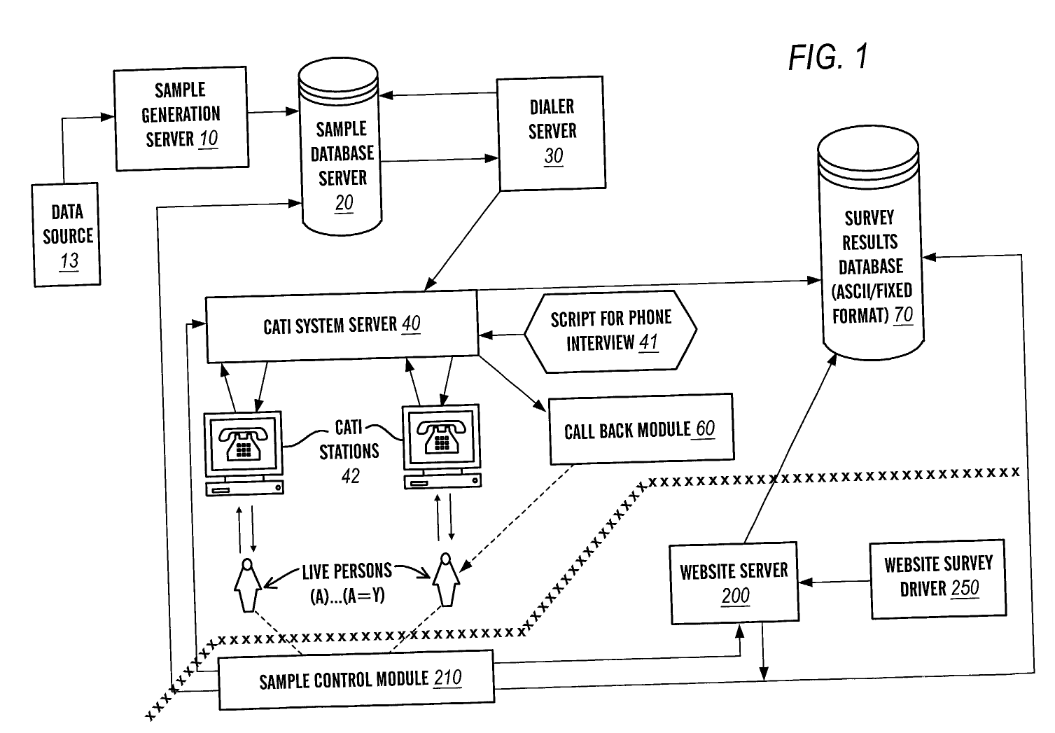

The following is a description of the components (apparatuses and systems) concerning the scientific sampling and recruiting of a population of Internet clients. Referencing FIGS. 1, 2, and 3 for the generation of the sample and completion of a survey of X interviews conducted scientifically to represent the responses of a given population.

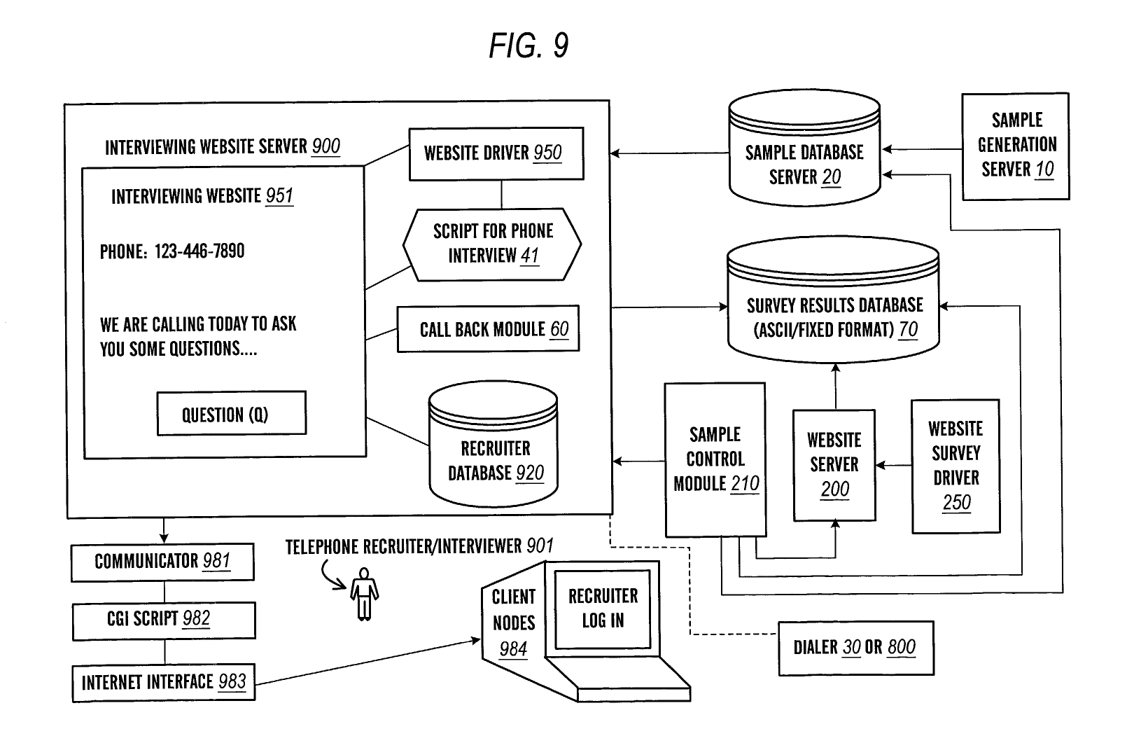

Each system or apparatus is referenced as a “server” or “database” or “module,” wherein, these terms respectively denote: an actual computer or hardware system (server), one or more tables for the storage of data (database), and a set of instructions provided either manually and interactively or through computer code language (modules). As one skilled in the art will understand, there are instances where the functionality denoted by such terms may be carried out by a different component or set of components, or where combinations of various functions can be carried out in one apparatus or component. For example, in FIG. 9 an alternative embodiment of the invention is illustrated, wherein many functionalities which are provided by multiple servers, for example, are provided through various modules running on one Internet server. In another example, various servers may generate the sample, store the sample, select a phone number, etc.; however, these functions could be carried out utilizing a single server and a set of code or modules designed to operationalize these functions. Such crossover could incorporate either client-server software or active server page software (as one skilled in the art will understand), and may incorporate either local area network (LAN) systems or wide area network (WAN) systems like the Internet.

A sample generation server (10) is a computer whose primary responsibility is the generation of a database of sample (21). The sample generation server (10) is a computer capable of reading between hundreds and millions of records, and writing those selected by the “nth select” in a reasonable amount of time given the computer's capabilities. A data source (13) which can be a CDRom, floppy disk, Internet download from ftp, or other file source containing a representation of the population (for the present invention, each member of the population is represented by a phone number) to be sampled in a readable file format, such as comma delimited, ASCII, or fixed width, is provided. Data source (13) is input to the sample generation server (10). The computer contains an executable file called the sample specification instructions (12), which include the specific instructions concerning the total number of clusters N=X to be selected and the total number of sample members per cluster A=Y. It also includes the instructions for conducting the “passes” and determines the value “N” for the “nth select” as described above. The selection module (11) receives instructions from the sample specification instructions file (12) and begins performing an “nth select” as described above and conducts the necessary passes through records contained on the data source (13) to write the scientifically selected individual records as sample members A to an ASCII file called database of sample (21). The sample generation server (10) thus communicates with a selection module to write to a Sample Database Server (20) which stores this ASCII format file called Database of Sample (21) containing telephone numbers representing individual households called sample members A grouped into distinct clusters N.

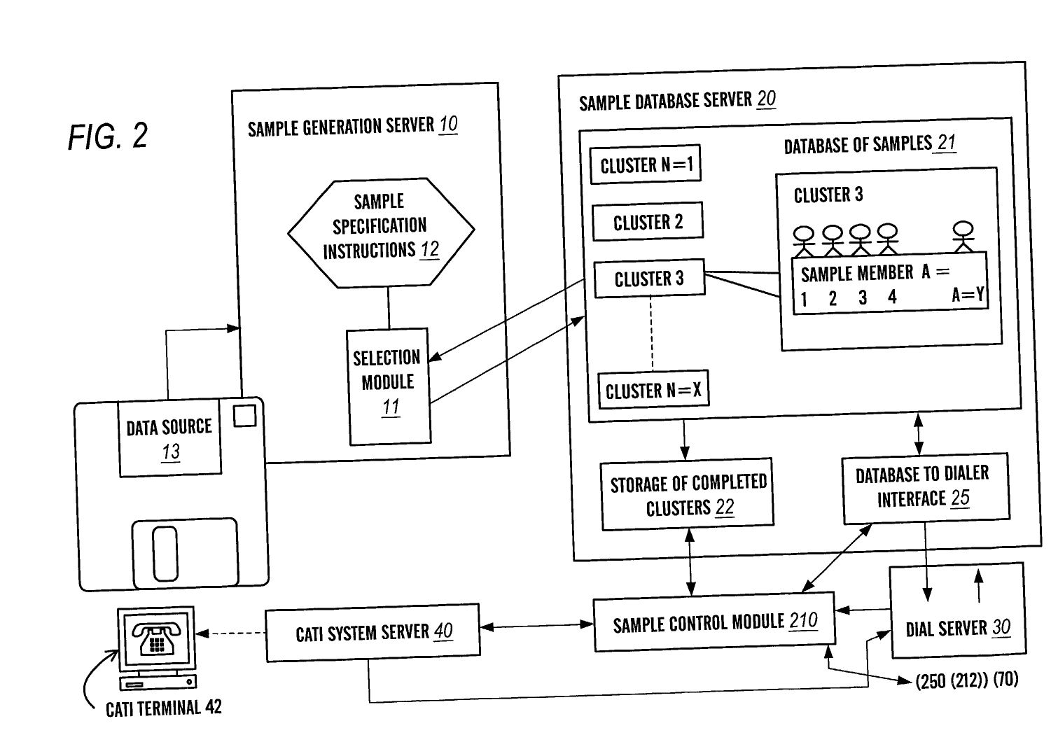

Each cluster is like a page which contains a list of phone numbers, with sample members on each page listed from A=1 to A=Y, where Y is the total number and A indicates the pass in which they were selected from the population during the “nth select” as represented in FIG. 2. Thus, those sample members in each cluster for which A=1 were selected on pass number 1, and those for which A=2 are those selected on pass number 2 from the population contained on the Data Source (13).

Sample database server (20) contains an apparatus called the database to dialer interface (25) which allows for the exchange of instructions and data from the sample database server (20) to other components (210, 30). The interface (25) receives an instruction from the sample control module (210) to select an individual sample member A from the database of sample (21), this database being, in one embodiment, a file stored within server (20), and its specific telephone number, and to output the telephone number to a dialer server (30). Dialer server (30) is a computational component for receiving a phone number and causing it to be dialed, either automatically or manually. The commonly available types of dialer servers (30) include a dialer component wherein a computer causes a phone number to be dialed: (i) manually (displaying the number to an individual that physically dials the number), (ii) automatically (the number is dialed as is by the computer) or (iii) “predictively” (i.e., when the computer dials a number and only patches through “live people” to the recruiter). The dialer server (30) provides a determination (either automatically or through inputs from the recruiter) as to whether the phone number, when dialed: (i) connects immediately to a person, (ii) a live number with no person answering within 4-5 rings or other outcomes from a live telephone number (as described below), or (iii) a dead number with no telephone service. Subsequently, the dialer server (30) outputs the determination to the sample control module (210). And, the dialer server (30), in the instance of the determination that a live person has answered, connects the live person to a computer aided terminal interviewing system (40) and then to individual terminal (42). In those cases where the recruiter is making the determination manually, the instructions for the dialing are passed by dialer server (30) to the CATI terminal (42) as soon as the number was selected from the sample database server (20).

The sample database server (20) also contains a file named stored completed clusters (22). This file is created as a result of instructions from sample control module (210) indicating that a specific cluster N has been completed and is represented in the survey. These instructions cause the sample database server (20) to write the cluster N from the available database (21) to the file (22) by deleting it without renumbering or in any way affecting the remaining clusters in database (21) and store the cluster in the file (22).

The CATI system server (40) is a computer with primary responsibility for the control and monitoring of the individual CATI terminal call stations (42). The CATI system server (40) communicates with the dialer server (30), as well as a hub, to pass a live telephone call with a live sample member A through to an individual terminal (42) and to provide the dialer server (30) with information necessary to make a determination of whether the live person agreed to participate, refused, or requested a call back at a later date. This data is communicated in turn by the dialer server (30) to the sample control module (210). A CATI terminal (42) is a computer which need not have high end functionality (i.e., a 486 mhz processor may be sufficient). The CATI terminal (42) operates on a network controlled by the server (40). Each CATI terminal (42) also has a telephone line directly running to it from the server (40) which connects each terminal (42) with the dialer server (30). Each terminal (42) has a headset with a telephonic capability that is connected to the terminal (42) and is connected to the phone line when a live person answers the telephone. The CATI system server downloads a script for phone interview (41) into each individual terminal (42) which is read out loud over the headset's speaker with questions and fields available for input of responses by a live telephone interviewer (40). Data input to the script constitute the data necessary for the dialer server (30) to make its determination concerning a live phone call as referenced above and any other necessary information for determining if sample member A qualifies for the survey. This process is referred to as “Screening.” Responses to questions concerning “Screening” are stored as data from script (41) by the CATI server (40) to the survey results database (70). This data is passed to the website server (200) to create a customized script for a qualified individual sample member A and is instrumental in the generation of the actual web pages by website survey driver (250) for when the respondent logs into website (200) to complete the survey.

CATI system server (40) also communicates with sample control module (210) and provides additional responses to the module's queries concerning the status of a sample member A.

In FIG. 9, an alternate embodiment of the present invention is shown where an IBIT (Internet Based Interviewing Terminal) can replace the CATI server. An IBIT system would run over the Internet, with a website replacing the CATI terminal in all functions, including those related to the employees (recruiters) and their maintenance, the scripts for the phone calling, the dialer server functionalities, the recording of all information to the appropriate databases, the calling of individuals and any other such functions associated with the CATI system. This alternative embodiment creates a new opportunity for telemarketing, telerecruiting, inbound or outbound market research, etc. where client server or LAN applications or a physical phone bank room or office are not necessary, and recruiters and supervisors (other employees of such firms) can work from home or any location with Internet access.

Returning to FIG. 1, CATI system server (40) also receives instructions from the sample control module (210) to trigger the call back module (60) which contacts a sample member A who has not completed a survey within a given time frame. This time frame is referred to herein as T.

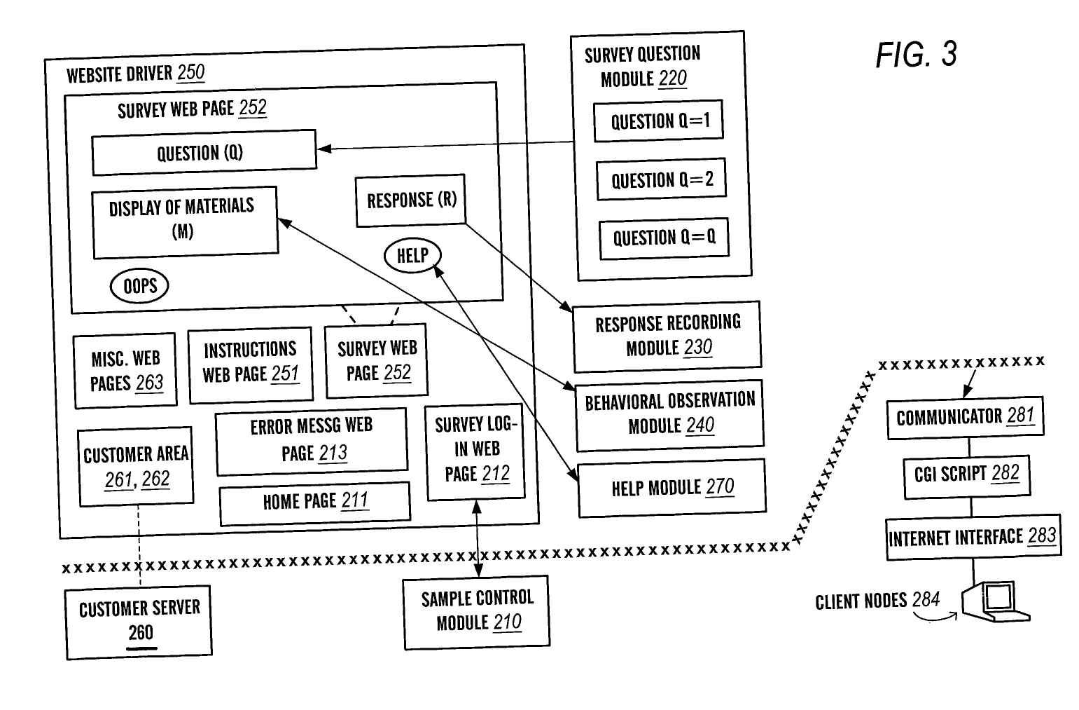

In regard to FIG. 3, this diagram represents the instance in which a Person Aₒ has qualified for the survey by passing through the Screening process, and additionally, has been invited to visit website (200) by a telephone interviewer at a CATI terminal (42). Also, a phone call is generated by the call back module (60) if an individual begins to complete a survey and logs off before completion. Also an e-mail can be sent out when an individual agrees to participate in a survey on the Internet with a link to the IP address for the website (200) to encourage their participation.

Person Aₒ is presumably seated at their Internet terminal, and has been contacted at the phone number provided at sample member A. Such a connection may be at home or at work or any such place that person Aₒ has access to the Internet. In the measurable future, Internet access will be available through devices which combine telephone and Internet functions, creating opportunities for the present invention to expand the abilities of research beyond those described herein. In addition the ability of individuals to access the Internet at increasing speeds increase the abilities of the present invention to include assessments of presentations involving video or interactive materials as well.

The IP address for website (200) is entered by the person Aₒ and is identified by their Internet browsing software. The browser directs person Aₒ to the introductory page for website (211). Data from person Aₒ triggers a website survey driver (250) and its appropriate modules and files (as discussed below in the section referencing the collection of survey data). Information gathered during the “Screening” questions and recorded to the survey results database (70) can be used to create customized surveys for person Aₒ based on their previous responses to the survey. Data concerning the status of person Aₒ is continuously recorded from the website by the survey driver (250) and then output to sample control module (210). These constant checks are an important aspect of the sample control module (210) and ensure that a scientific sample is being met and that sample members are being called, reminded, pushed back when they do not finish a survey, and that there is full integration and linkage between the website (200) and the sampling system. Also, if a person should break off and re-log in to complete a survey, the survey questions resume up exactly where they left off.

At the time of completion of a survey by person Aₒ the results of the survey are written as an ASCII fixed format file by website driver (250) and stored in survey results database (70). The completion of a survey also signals the website survey driver (250) to notify the sample control module (210) of a “complete survey” initiating the appropriate directions for closing a cluster N to the sample database server (20).

In the instance when an Internet client browsing the IP address of the website occurs, a customer server (60) is provided to process customer requests or process miscellaneous requests. A backup system (not shown) is provided to duplicate the Internet interface, world wide server, CGI script, and communicator to eliminate the response error resulting from the website (200) not being available to sample members A. The communicator component allows for any version of Internet (more generally, network) browser and/or modem speed from the client node for responses to a survey thereby reducing the response error caused by discrepancies between sample members having different browser or modem capabilities and resulting compatibility issues.

The following is a description of the method concerning the scientific sampling of a population of Internet clients wherein FIGS. 1, 2 and 4 are referenced.

The method begins with the identification of a population to be surveyed in step 401. A determination is then made whether a complete list of the population can be obtained, with each member of the population represented by a telephone number in step 402. If such a list is available, then the list sampling method is utilized for the creation of sample database (21). More information on the list sampling and RDD sampling methods is found below. The list of the population is obtained in electronic form as a data source (13). The data source is loaded onto the sample generation server (10) in step 403. The sample specification instructions (12) file is created with specific instructions for reading from data source (13) and writing a new file, called sample of database (21), which is stored in the sample database server (20) in step 404. Accordingly in step 405 the selection module (11) then performs an “nth select” according to the instructions given by the instructions file (12) and creates a database of sample (21) including clusters N=1 through N=X, where X is the total number of interviews desired for the survey. Each cluster N contains sample members A=1 through A=Y where Y is the total number of sample members selected from the population for each cluster N. The selection module (11) writes the cluster number N along with the telephone numbers and other data concerning sample members A to the database of sample (21).

If no such phone list is available, the RDD method of sampling is utilized. Geographic areas which contain the entire population are identified in step 406. A number (the desired number of interviews, equal to X, of RDD replicants are purchased from the telephone company which provide a random set of sample members within the desired geographic area. Each replicant represents a unique geographic area within the overall population area as identified by the first 3-digits of each phone number is stored on an electronic data source as a data source (13). The data source (13) is loaded into the sample generation server (10) and imported directly into sample database (21) by the selection module (11). As each replicant is exported to database server (20) in step 408 it is assigned a number N and can now be considered a cluster just as in the situation of list sampling (where a cluster is a randomly selected group of sample members from a similar geographic area representing a desired sample point for an interview for a survey).

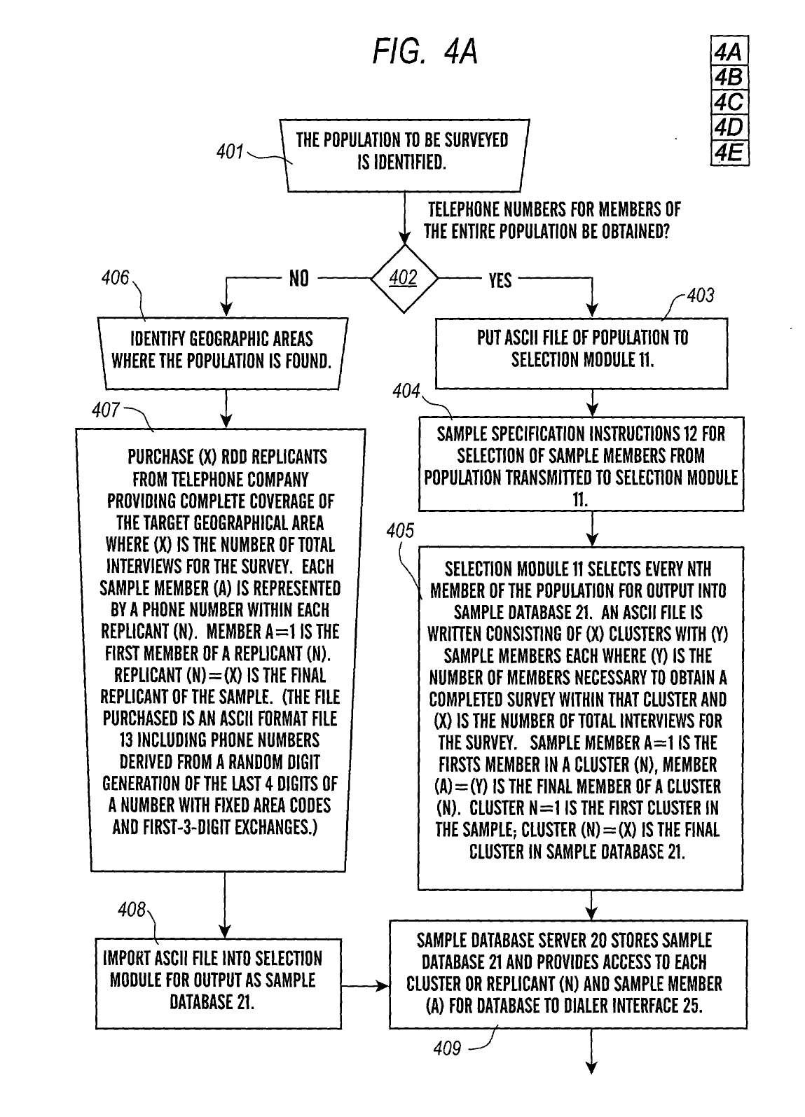

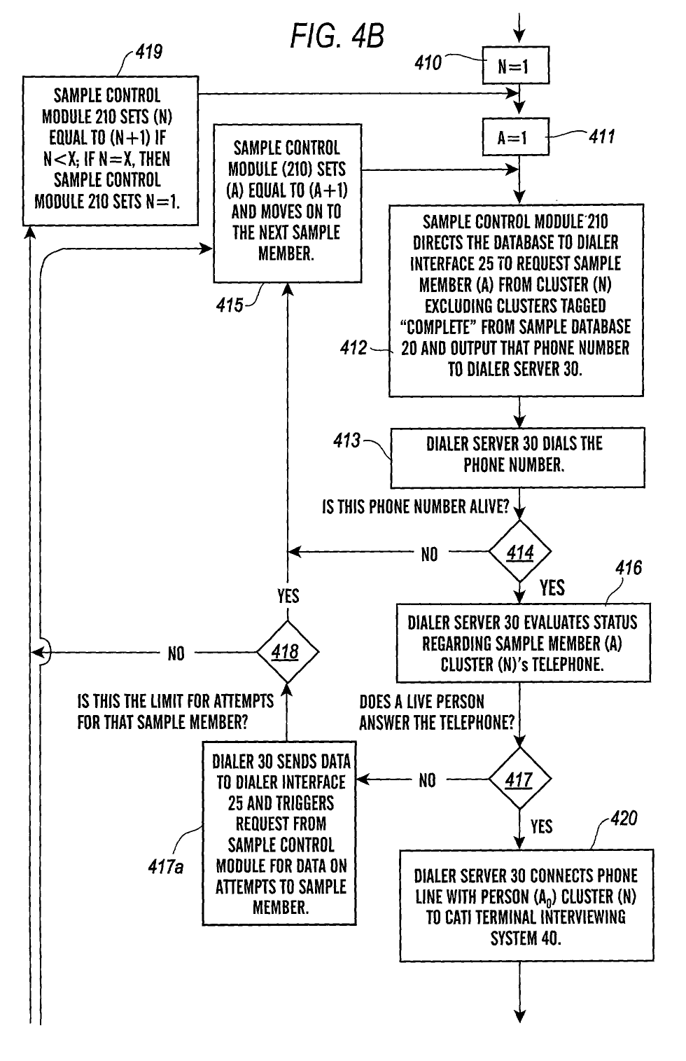

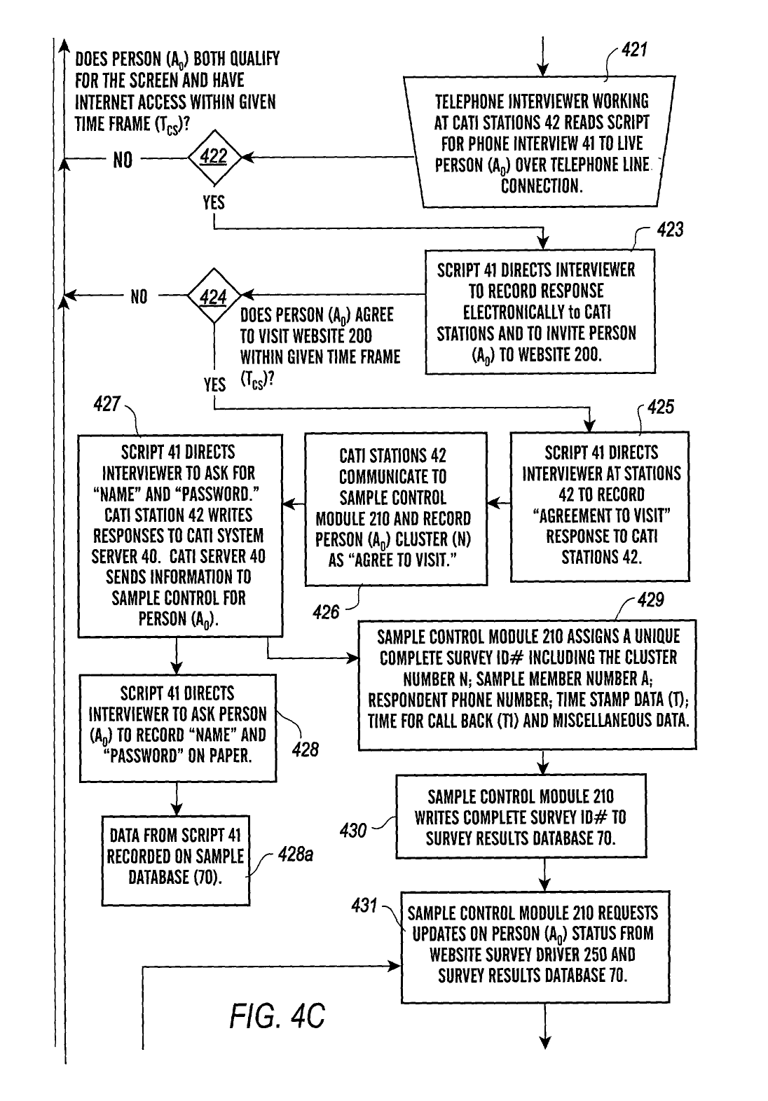

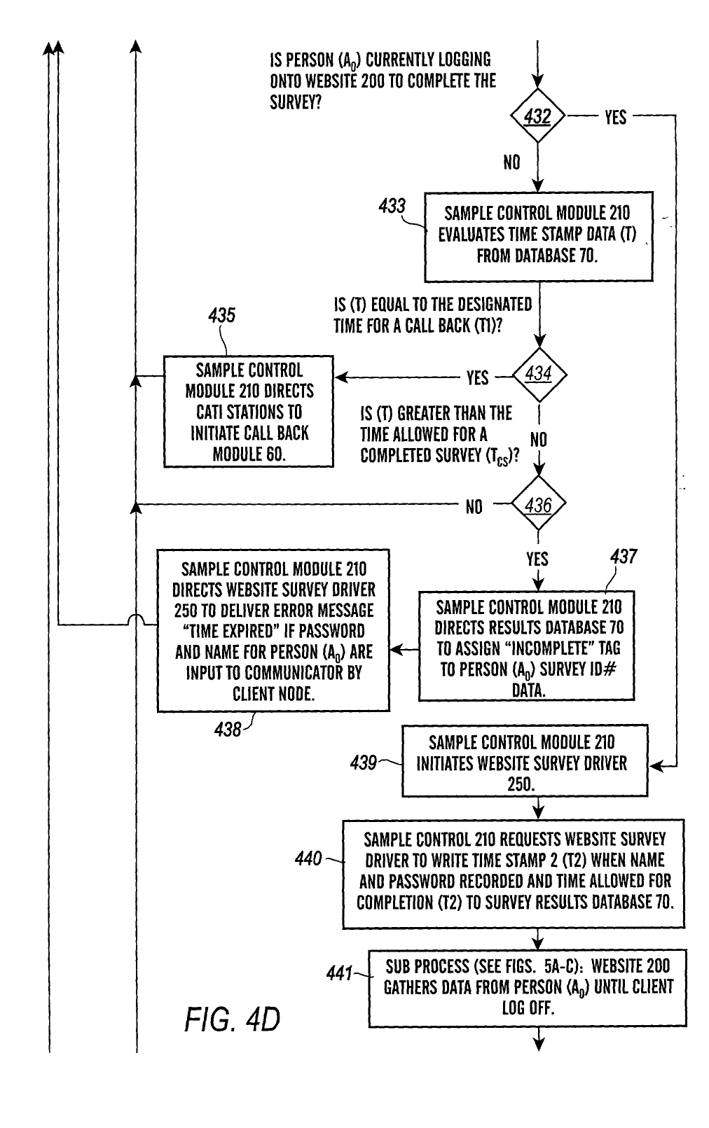

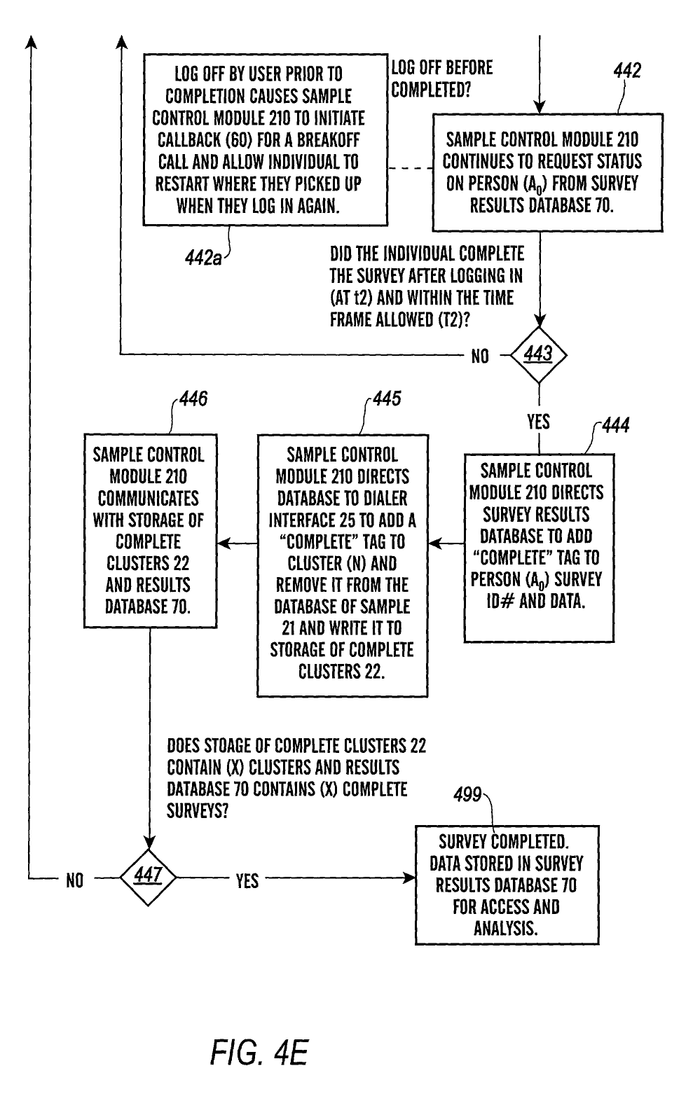

Sample server (20) now stores a sample database file (21) having clusters N with sample members A. Sample server (20) also contains the database to dialer interface (25). FIG. 4 flowchart illustrates the method used for selecting a sample member A from cluster N with the desired outcome of having sample member A visit the website (200) through an Internet connection and completing a survey and therefore completing the desired interview corresponding to cluster N until all clusters N are filled and X interviews have been completed. In FIG. 4, the flow chart also shows at each stage how effort is made to continuously recruit the “best-fit” sample member for each cluster N, with sample member A=1 the most preferred and more desirable than A=2, and A=2 more desirable than A=3, and so forth, as described above in the Definition of Terms, in order to accomplish random sampling requirements.

The flowchart sets N=1 and A=1 in steps 410 and 411, respectively.

The sample control module (210) directs the database to dialer interface (25) to select the sample member A from cluster N. Database to dialer interface (25) only has access to those clusters N which have not been written to the storage of complete clusters (22) and marked as complete in step 412. Database to dialer interface writes that telephone number to the dialer server (30) in step 412. Dialer server (30) then causes that number to be dialed either manually, automatically, or predictively in step 413. A determination is made (input or through automatic detection) by the dialer server (30) as to whether the phone number is alive or dead in step 414. A phone number is considered “alive” if an actual ‘ringing’ signal occurs; if an error message or no connection is received, the phone number is considered “dead.” If a phone number is dead, the dialer communicates to the sample control module (210) which eliminates sample member A from its consideration and begins targeting sample member A=A+1, i.e., the next highest sample member, for recruitment in step 415.

If the dialer server (30) results in the initial determination that a phone number is “alive” a determination is made concerning the outcome of this “attempt” in step 416 The determination is made whether a live person actually answers the telephone by the dialer server (30) in step 417. If a live person does not answer the telephone and an answering machine or no answer or other outcome is encountered, the dialer server (30) sends data to the sample control module (210) and an “attempt” is recorded to that phone number in step 417a. The sample control module (210) then evaluates whether this “attempt” which was recorded is in excess of the number of attempts which are being allowed per sample member A if no live person answers in step 418. The number of attempts to be tried per sample member telephone number is typically pre-determined and varies according to the survey in question. Standard telephone practices used today typically attempt each live phone number three to four times. If such a limit for attempts has been reached, the sample control module (210) eliminates sample member A from its consideration and begins targeting sample member A=A+1, i.e., the next highest sample member, for recruitment in step 415. If the limit has not been reached, the sample control module (210) temporarily ceases efforts to recruit sample member A from cluster N and begins to attempt to recruit for cluster N=N+1 in step 419. This process, beginning at step 412 with the selection of a sample member A, will restart, and cluster N will again be considered, in each instance where the final cluster N=X has been attempted but the entire survey has not been completed; i.e., before all clusters N=1 through N=X have been filled and written to the storage of complete clusters (22).

When a live person Aₒ answers the telephone, the dialer server (30) patches the live telephone signal through to the CATI terminal interviewing system (40) in step 420. The CATI server (40) then patches the phone call through to one of the terminal interviewing stations (42). The script for phone interview (41) appears on the computer screen of the telephone interviewer stationed at the particular terminal (42). The script (41) is read by the interviewer (or telemarketer) and data is collected by the interviewer from the live person Aₒ and input manually as numeric or alpha responses to the questions/fields required by the script for phone interview (41) and stored as data from script (41) in the sample results database (70) in step 421.

A determination of two factors is made by the interviewer in step 422. The first factor determined is whether person Aₒ or another person available at sample member A (i.e., a telephone representing the household where person Aₒ lives) qualifies for the particular screening for any demographic or other characteristics which a survey might require. The second factor determined is whether person Aₒ who has qualified will also have access to the Internet within a given time frame T. This time frame T will vary in regard to each survey, most typically it will be 48-72 hours. “Access to the Internet” refers to any potential computer with an Internet service provider for accessing and surfing the World Wide Web that person Aₒ can access within time period T. This can include computers at the home, work, library, or school of person Aₒ, or another location, or it can include a personal display device with Internet capability. If a sample member A does not have a person Aₒ who both qualifies for any screener and also does not have access to the Internet within a given time frame T then the sample control module eliminates sample member A from its consideration and begins targeting the sample member identified by A=A+1, i.e., the next highest sample member, for recruitment in step 415.

If Person Aₒ of sample member A both qualifies and has access to the Internet within time frame T as reflected by the data input to terminal (42), the script for phone interview (41) continues. Script (41) directs the interviewer to read an invitation to visit website (200) by time frame T by surfing the Internet and entering the IP (Internet Protocol) address into their browser window. This IP address may be, e.g., any accessible web address, where respondents are able to either remember or otherwise easily find the IP at a later time when they decide to log in and complete a survey. Any number and variety of pre-determined incentives may be offered to encourage the person Aₒ from sample member A to visit website (200) by given time frame T as part of this script (41). Script (41) then requests a data input to terminal (42) in step 423. A determination is now made as to whether person Aₒ has agreed to visit website (200) within the given time frame T in step 424. If person Aₒ at sample member A has declined the invitation then the sample control module (210) eliminates sample member A from its consideration and begins targeting the sample member for A+1, i.e., the next highest sample member, for recruitment in step 415.

If Person Aₒ of sample member A agrees to visit the website (200) within time frame T then data is input to terminal (42) by the interviewer indicating “Agreement to Visit” has been obtained by the interviewer in step 425. Terminal (42) then communicates to sample control module (210) which assigns sample member A a code reflecting the status of “Agreement to Visit” in step 426. Sample control module (210) requests a “NAME” and “PASSWORD” entry from terminal (42) (via the CATI server (40)). Script (41) then directs the interviewer to request a “NAME” and “PASSWORD” from person Aₒ. Interviewer, at the direction of script (41), inputs the “NAME” and “PASSWORD” to terminal (42) which records the responses and writes the “NAME” and “PASSWORD” to the CATI server (40) 427. Script (41) directs the interviewer to ask person Aₒ to record their individual “NAME” and “PASSWORD” on paper or other suitable recording device such as a personal planner or electronic organizer, and to also record a self-reminder to visit website (200) and complete the survey within time frame T in step 428. An e-mail address can also be requested from the individual which is input to the terminal (42) which can then be used to send e-mail message with text and a link to the website (200) to encourage participation in the survey. CATI server (40) writes the “NAME” and “PASSWORD” to the sample control module (210), which then assigns a unique identification number (Survey ID number) including the cluster number N, the telephone number for sample member A, the “NAME” and “PASSWORD,” a time stamp T of the time of day and date of the current phone interview, responses to any screening or other preliminary questions, and a randomly generated four numerical digit extension in step 429. Subsequently, in step 430 Sample control module (210) stores this information for communication with website driver (250) from the web page “Introduction to Web Page” (211) while sending a copy of the data corresponding to sample member A to the survey results database (70) for storage.

In step 431, sample control module (210) requests continuous updates on person Aₒ status from the website survey driver (250) and survey results database (70). At each instance a determination is made as to whether person Aₒ is currently logging on to website server (200) and the introduction web page (211) to begin completing the survey in step 432. If person Aₒ is not currently on the introduction web page (211) then sample control module (210) evaluates time stamp data T for person Aₒ in step 433. A pre-determined time is set for when a call back is to be issued to person Aₒ if they have not yet visited the website (200) to complete the survey. A determination is now made by the sample control module (210) as to whether time stamp T is equal to this predetermined time for when a call back is to be issues in step 434. If this is the case, then in step 435, call back module (60) is initialized and a reminder phone call is made to person Aₒ by the CATI server (40) using either an automated message or a telephone interviewer as directed by call back module (60).

If the time stamp T is not equal to time for a call back (designated in the Figures as “t1”), then, in step 436, another determination is made by the sample control module (210) as to whether T has exceeded the time allowed for person Aₒ to visit the website and complete a survey (designated in the figures as “T”). If the time allowed for person Aₒ to visit the website (200) and complete a survey has been exceeded and person Aₒ has not visited the website (200) in their allotted time then sample control module (210) adds the tag of “INCOMPLETE” to the string of data initially gathered at the time of the call which includes the Cluster ID number in the sample control module (210) and sample results database (70) in step 437. Sample control module (210) will now consider this individual Sample Member and its affiliated Cluster ID number and its associated “NAME” and “PASSWORD” as invalid and will direct website driver (250) to display the error web page (215) if said “NAME” and “PASSWORD” are entered after by a live person in step 438. Sample control module (210) then eliminates sample member A from its consideration and begins targeting the sample member for A+1, i.e., the next highest sample member, for recruitment in step 415.

If person Aₒ is currently logging on to website (200) to complete the survey and is currently inputting their “NAME” and “PASSWORD” to the introduction web page (211), then sample control module initiates the website survey driver (250) in step 439. Sample control module (210) requests that website survey driver (250) write a time stamp “t”. A pre-determined amount of time is given for the person Aₒ to complete the survey after they have initially given their “NAME” and “PASSWORD” to the website (200) (this time is called t3). These times t2 and T2 are written to the survey results database and appended to the string of data begun for person Aₒ including cluster number N, sample number A, phone number, etc. in step 440.

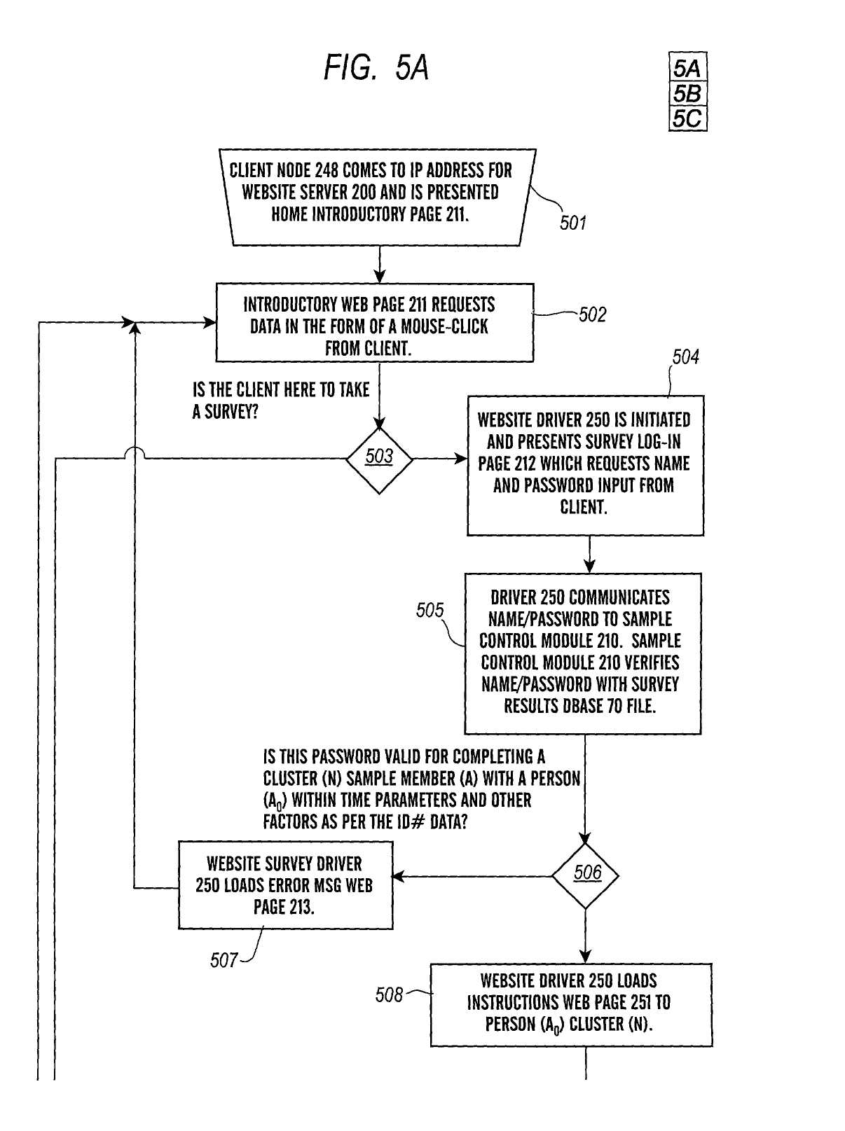

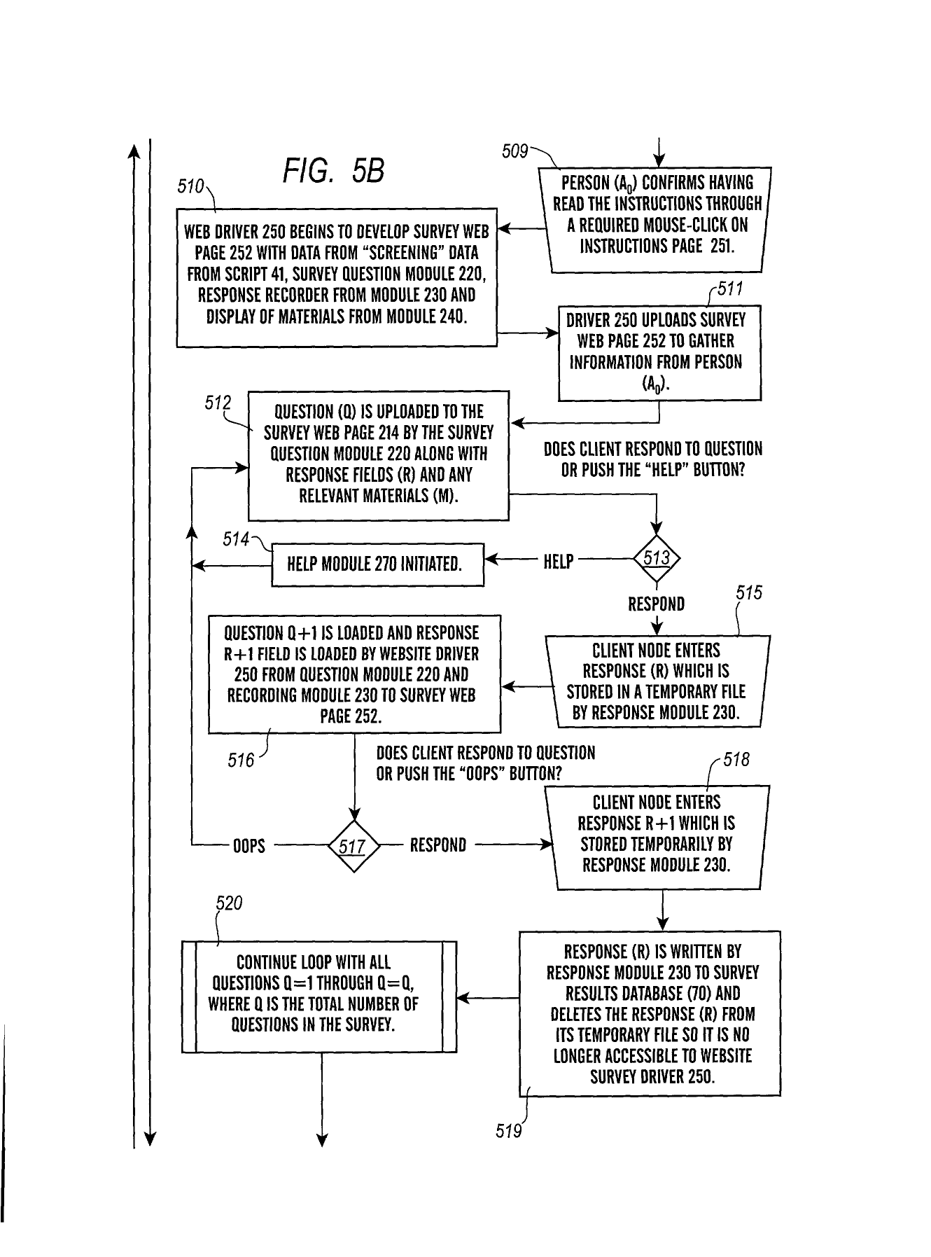

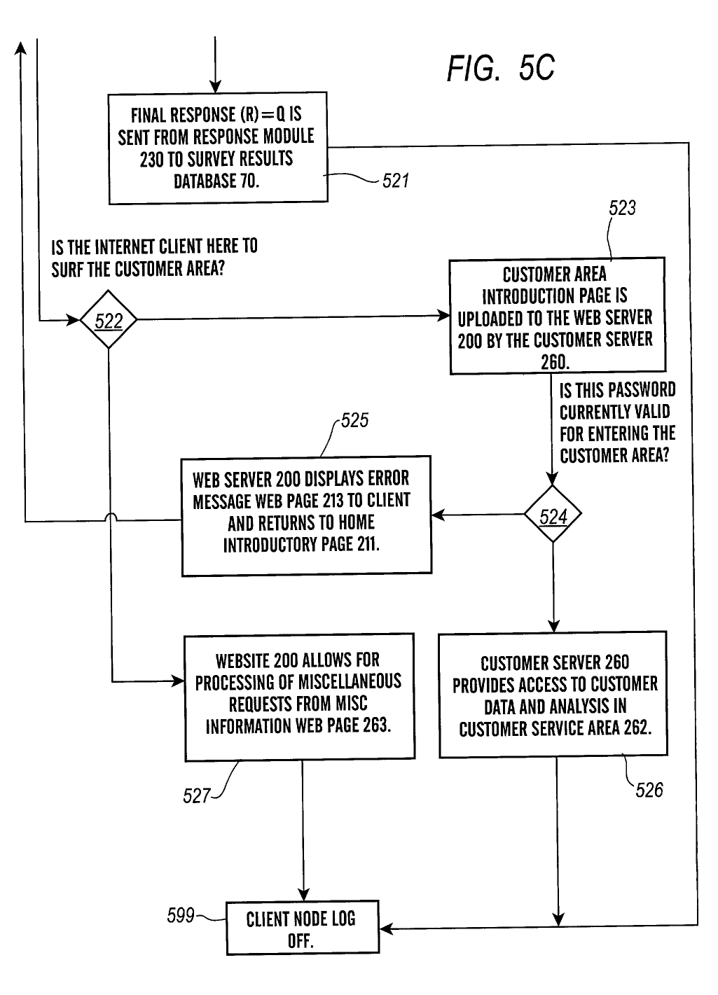

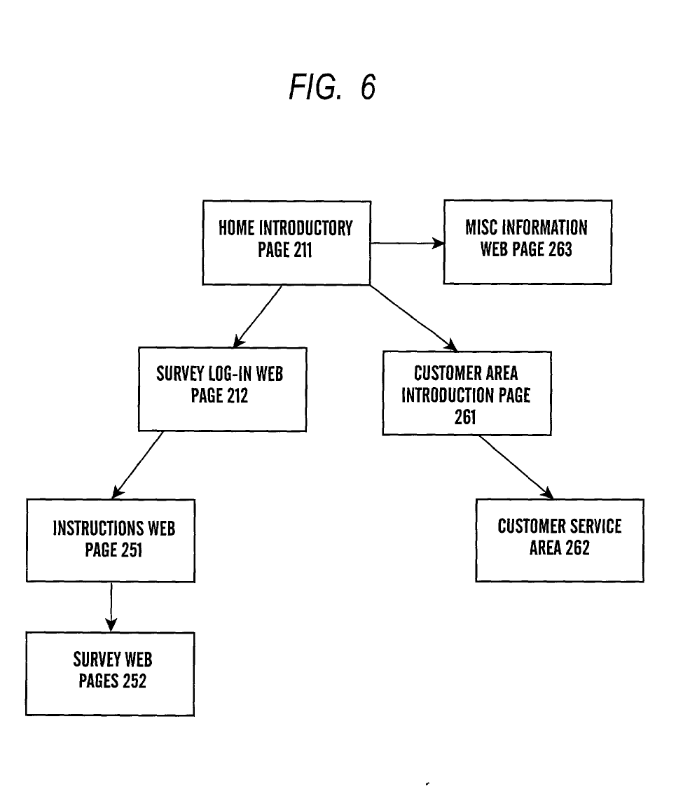

Once a person logs on the website (200) they continue through until the logging off event occurs. This process is described in FIGS. 3, 5 and 6. While person Aₒ is on website (200) responding to the survey, the sample control module (210) continues constant requests for status for person Aₒ from survey results database (70) in step 442. If the survey is begun but not completed (i.e., there is a log off before completion), the sample control module (210) directs the call back module (60) to generate a phone call to encourage person Aₒ to complete the survey, and when the person logs in again to the website (200) to finish, the sample control module (210) instructs the website driver (250) to continue the survey questions at the point where the individual broke off, and not at the very beginning, in step 442a. In step 443, a determination is made whether the person did or did not complete the survey within the time allowed (from when they came online t2 to when the time limit T2 occurs). If not, the sample control module (210) begins communicating again with website survey driver (250) to see if the person is currently logging on to complete the survey in step 431. If the survey has been completed within the time allowed, then, in step 444, the sample control module (210) directs the survey results database (70) to add a “COMPLETE” tag to the corresponding record for person Aₒ (the string of data begun in step 429). The sample control module (210) directs the database to dialer interface to write a “COMPLETE” tag to cluster N and cut and paste it (i.e., delete it from and write it to) the storage of complete clusters (22) in step 445.

The sample control module (210) communicates with storage of complete clusters (22) and survey results database (70) in step 446. A determination is made as to whether both the storage of complete clusters (22) and the survey results database (70) contain the total number of complete clusters and surveys equal to the value X which is the total number of interviews required for completion. If the survey has not been completed, then the sample control module (210) moves on to the next cluster N+1 in the case where N<X; in the case where N=X, N is reset to one (1) and the first cluster available which is not tagged with a “COMPLETE” is attempted (i.e., the sample member with the highest value for A in the next cluster is dialed) in step 419. This allows for clusters to be “paused”, in order to allow additional attempts to a sample member A before moving on to sample member A+1, while allowing the method to continue unabated.

In step 448, if survey results database (70) and storage of complete clusters (22) are full (i.e., contain clusters/surveys equal to X), then the survey results database (70) stores the completed surveys for access for analysis and other purposes in an ASCII file format and the survey is considered finished.

The following is a description of components for the website apparatus for the collection of survey data. With reference to FIGS. 1, 3, 6 & 7, the collection of data where questionnaire Q having questions q, responses r and materials m is administered over the Internet to persons Aₒ derived by contacting sample members A who have been invited and have logged on to website (200) within a given time frame T to complete a survey interview. As illustrated in the figures, the components are also shown which operate in those instances in which an Internet client logging on to website (200) is not on the website to complete a survey as well.

The website server (200) is the computer which hosts the Internet files (HTML or other applicable formats) and necessary modules for collecting the data in question and allowing for rich media to be included in the survey questioning. The website server (200) communicates with the sample control module (210) for information concerning the “NAME” and “PASSWORD” of individuals and for monitoring of the sampling of the population as referenced above and for generating all associated phone calls, reminders and other processes. The website server (200) also communicates with the survey results database (70) by writing the responses (r) in an ASCII file format once the total number of surveys X are completed. On the website server (200) resides the website survey driver (250) which governs the functions involved in displaying the web pages regarding surveys and collecting data responses r and displaying and evaluating materials m as well as the appropriate web pages of HTML script for displaying visual and interactive presentations and simultaneously facilitating interaction between the Internet client (284) and the website (200). The home web page (211) is an HTML file which contains the first page which is accessed from the website server (200) by an Internet client (284) which provides introductory visuals or audio for the client. The survey log in web page (212) is an HTML file which includes the fields requesting the client to input their “NAME” and “PASSWORD” which is communicated to the sample control module (210). An error message web page (213) is an HTML file containing the message “invalid name/password” for display to Internet clients. The instructions web page (251) is an HTML file including the instructions for a person Aₒ who has qualified to and is responding to a survey to do so.

The survey web pages (252) are the HTML pages which are designed to gather survey data from a person Aₒ responding to the survey on the website (200). The survey questions module (220) is the file containing the instructions for displaying the text to each individual question q as well as the logic for ordering of the questions and the display of the correct questions based on any logic statements or conditions necessary based on prior “Screening” questions and data from script (41), split samples, clustering or grouping of respondents or any other specifics relevant to the proper administration of the survey questionnaire containing Q questions.

The response recording module (230) carries primary responsibility for uploading the proper field for acquiring a response r to the specific question q to which the r is relevant. This module includes the ability to display text or graphic interfaces for Internet client to “click” on and therefore initiate a writing of specific numeric, action-oriented, verbal, audio or other form of response which is sent by the response recording module from the web server (200) to the survey results database (70). The behavioral observation module (240) stores a file within it, in digital format, of the materials m to be evaluated by the survey questions which can be uploaded to the survey web page (252). The behavioral observation module (240) also enables an action-recorder which monitors the interaction between the Internet client in the way they browse and “click” as regarding the initial viewing of, and reactions to, materials m. Note that materials m include any presentation or image or continuous images with or without accompanying audio which can be displayed in digital format and through bandwidths allowing for any potential sample member A to view them in a reasonable manner and without download times that would cause a person Aₒ taking the survey to break off and not complete the survey.

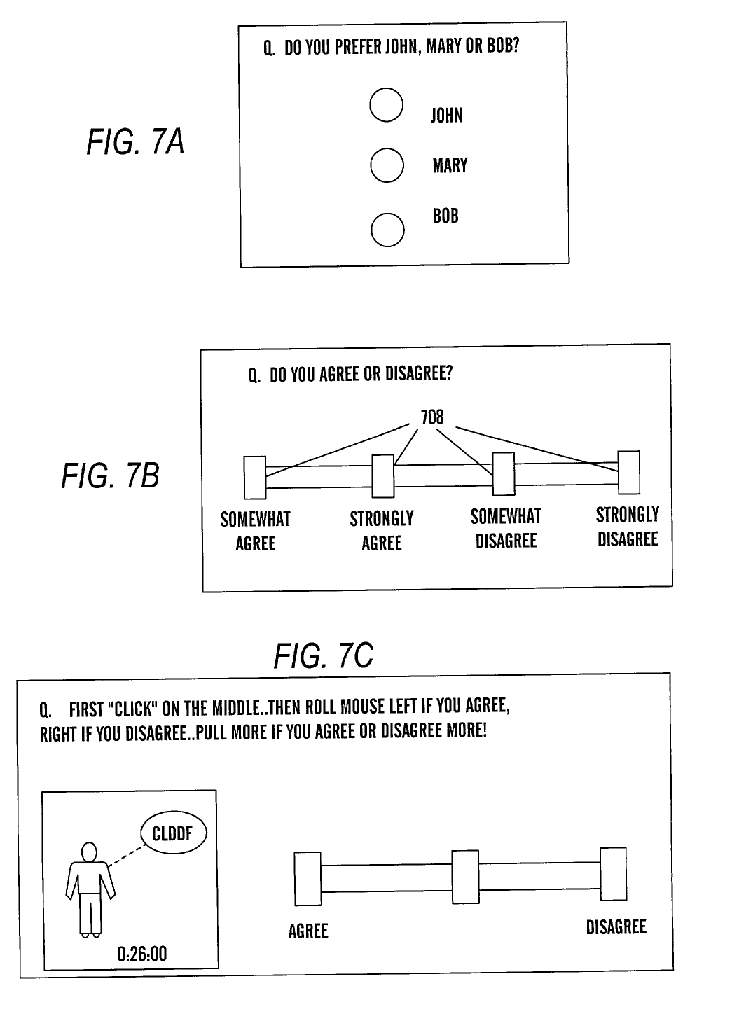

The design of survey web pages (252) varies depending on the nature of the information desired and the type of inputting which will optimally allow for this information to be recorded from the person Aₒ in a clear and reliable manner. The FIGS. 7A-7C show three types of survey pages (252), with the latter two being unique to this invention. “Radio buttons” or direct “mouse clicks” will be utilized for unique fields or values where a clear and unique choice is made through a close-ended question, as in FIG. 7A.

In the instances where a continuous set of values is desired (for close-ended questions where responses can be assigned discreet values in a continuous stream) a graphically presented “strip” will appear below the corresponding question q and will allow for responses either on the labeled portions (708) (e.g., by “clicking” on strongly agree in FIG. 7B a value of “1” is recorded) or on any location on the strip to record any non-integer fraction or percentage value based on the distance from the whole number values (i.e., clicking directly in between the strongly agree and somewhat agree responses a value of “1.5” is recorded as a response r to this question). Another question type allows for respondents to enter open-ended responses in their own words to a question q by presenting a standard text box for input by person Aₒ and recording by module (230). In the instances where materials m are presented and are a continuous stream of video or audio, a “keyboard/mouse dialer” type question may be utilized as displayed in FIG. 7C. In this instance the person Aₒ is asked to center their “mouse pointer” over the “zero” marker in the middle of the “strip” on the page, and then as the materials m are presented, to move the “mouse pointer” or to utilize the “left” and “right” arrows to indicate either a positive or negative reaction, with the intensity of the reaction indicated by the distance from the center point on the “strip.” Other question types and designs may also be utilized for survey web pages (252), as one skilled in the art will understand.

The help module (270) is initiated by the HELP button (271) and carries the files necessary to provide online assistance to an Internet client with a question about the functionality and interactivity of the website survey (200). The OOPS button (272) allows for the Internet client to alter their response to the question immediately previous but not to any other questions that have already been recorded and sent to the survey results database (70). The customer server (260) is a computer which contains the files relevant to customer requests for project management or analysis or reporting of data which a customer can access through customer service area web pages (262) as well as the misc. information web pages (263).

The following is a description of the method for the collection of survey data. With reference to FIGS. 1, 3 5 and 6, the collection of data where questionnaire Q includes questions q, responses r and materials m, is administered over the Internet to persons Aₒ derived by contacting sample members A who have been invited and have logged on to website (200) within a given time frame T to complete a survey interview. It also references the components which operate in those instances in which an Internet client logging on to website (200) is not on the website (200) to complete a survey.

A client node (248) logs in to website (200) by logging on to the IP (Internet Protocol) address at their terminal through the World Wide Web. The home introductory page (211) is uploaded by the World Wide Web to the communicator (281) and translated as an HTML file into a visual image appearing on the client node's (248) monitor at their terminal in step 501. In step 502, the home page (211) requests an input of one of three fields from the respondent in order to make a determination as to their purpose in visiting website (200). In step 503, if the client (248) is logged on to the website (200) in order to respond to the survey, the client communicates this through a “mouse click” on the introductory web page (211) in an area entitled “Take a Survey” or the like.

Step 503 (the clicking on the “Take a Survey” area) initiates the website survey driver (250) which causes the website server (200) to upload the survey log in web page (212) to the communicator (281) for display to client (284). The log in page (212) requests an input requiring the completion of a text response to both the NAME? and PASSWORD? questions which are input by client node (284) in step 504. The website driver (250) sends the responses given by the client node (284) to the sample control module (210). In step 505, the sample control module (210) verifies that the NAME and PASSWORD input by the client node match a valid person Aₒ for taking a survey by verifying the survey ID number stored in the survey results database (70). In step 506, a determination is then made as to whether this client node (284) is indeed a valid respondent for the survey for completing a cluster N of sample member A within the given time parameters for response. If the client node enters an invalid NAME and/or PASSWORD or enters a valid NAME and PASSWORD but is not within the time allowed for taking the survey T then website survey driver (250) loads the error message web page (213) into the communicator (281) for display to the client (284) in step 507. If the NAME and PASSWORD are valid and the client (284) is within the given time frame T then they can be considered the same as a person Aₒ and can take the survey. If appropriate the data from script (41) recorded to the database of results (70) can be accessed by the website driver (250) to build an individualized set of questions or a survey based on that person's responses to the screening questions. The website driver (250) thus loads the instructions web page (251) to the communicator (281) for display to person Aₒ at their terminal (284). Person Aₒ confirms having read or heard the instructions by responding to a required field “CONTINUE” with a “mouse-click” in step 509. The web page (251) then sends this signal from the “mouse-click” initiating the survey and requesting web driver (250) to upload the first survey web page (252) for person Aₒ to respond to the survey. The information for the survey web pages (252) is used to create a web page where the person Aₒ can view and respond to survey questions, with information used to build a page including the question from the question module (220), the response fields and the responses r from the response module (230), and materials m (if any) by the behavioral observation module (240) in step 510.

Once the web page (252) is ready it is uploaded to the communicator (281) for person Aₒ to view or listen to and respond to through input by “mouse-clicks” or text entries or otherwise interacting with the web page (252) in step 511. Person Aₒ's “mouse-click” is read by the response recorder module (230) and a determination is made regarding their input in step 512. First, if person Aₒ pushes the HELP button, the help module (270) is initiated and provides a web page upload of the information concerning the operations of responding to a survey in steps 513-514. The HELP module can also have the capability of including a “Live Chat” option where an employee can help the respondent over the Internet through a 2-way pop-up chat window. In step 515, if person Aₒ has “mouse-clicked” on the response r then this response r is stored in a temporary file in the web server (200) by the response module (230) to be written to the survey results database (70) once the response r+1 has been input by the person Aₒ. Question q+1 and responses (r+1) are loaded by the website driver (250) into a new survey question web page (252) in step 516. Person Aₒ's “mouse-click” is again read by the response recorder module (230) and a determination is made regarding their input. In step 517, if the client has pushed the OOPS button, they are returned to the previous survey web page (252) for question q and are given the opportunity to correct a mistake on the previous question. If person Aₒ responds by pushing on a “click” within the response field and thereby generating a response r+1, then response r+1 is now stored in the temporary file within web server (200) by response module (230) in step 518. Response r is then written by the response module (230) and appended to the string of data and ID number which is associated with the person Aₒ in the sample results database (70) and is deleted from the web server (200) temporary file so it is no longer accessible and person Aₒ will not be able to alter the response to question q once question q+1 has been answered according to step 519. This loop for building the survey questions (steps 510-519) continues with web pages being provided for the respondent including questions and responses until all of the questions in the survey Q have been answered, as outlined in step 520. If there should be a log off event before the completion of the entire set of survey questions Q, the sample control module (210) initiates the call back module (60) to generate an ‘online breakoff’ phone call and allow the person Aₒ to log in again and continue the survey where they left off (as noted in FIG. 4, step 442a). Once the final response to the survey is recorded by the response module (230) to survey results database (70) the survey is completed and the client node can either log off or return to the home introductory page (211) according to step 599.

In step 522, if the Internet client (284) is not on the website (200) to take a survey, then a determination is made regarding their input as to whether they are a customer visiting the website (200) in order to browse the customer area.. If so, the customer area introduction page (261) appears and asks for a valid customer password for entering the Client Area (262) in step 524. Accordingly, in step 525, if a valid password is not entered by the customer, then the error page (213) is uploaded and the client is automatically returned to home introductory page (211). In step 526, if the password is correct then the client (284) is given access to the customer service area (262) where they can access relevant questionnaires, results or any analysis or other services a customer may require which is available to them through the service area (262).

In step 527, if the Internet client (284) is not on the website (200) to either take a survey or go to the customer service area (262), then they are allowed access to the miscellaneous information web pages (263) and the website (200) processes any miscellaneous requests from the Client (284). Finally, in step 599, the process ends at any time when the client (284) exits the website and logs off.

Alternative Embodiments of the Present Invention:

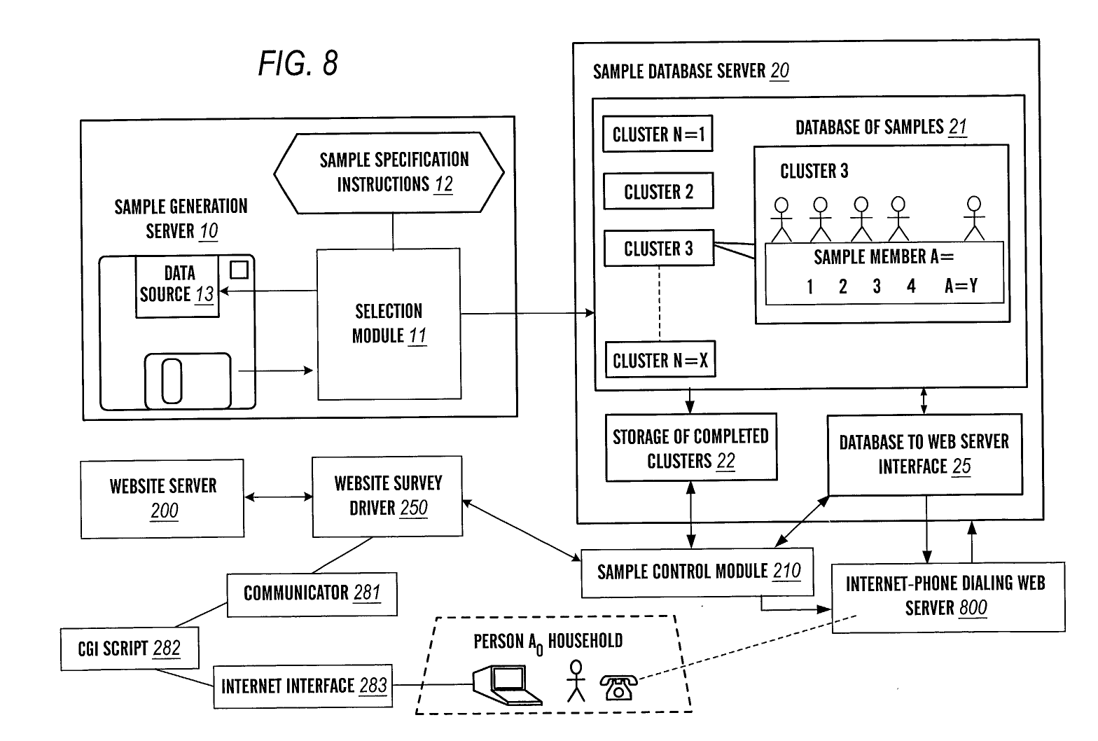

A description of the components and systems described in FIG. 8 and FIG. 9 are described herein.

The following is a description of the FIG. 8 components and system concerning the scientific Sampling and Recruiting of a Population of Internet clients utilizing an Internet to phone dialer (800). The advantages of the Internet to the phone dialer server (800) include that it allows for the elimination of long distance calling in the sampling of a population for telephone polling and the realization of significant cost savings and further that such a web-based server allows the full integration into a single web-driven computer system for the sampling of a population for Internet surveys. The Internet to phone dialing web server (800) replaces dialer server (30) in the sampling of a population for any survey that is to be contacted by telephone.

Rather than the phone call being placed externally (through a manual dial, auto-dial, or predictive dial) from the CATI or Internet based interviewing terminal systems (the system created by the present invention and referenced in FIG. 9) utilized in recruiting respondents through a phone line that is separate from the data lines, the phone call would be placed internally, within the system, through the data lines and over the Internet. By doing this, the Internet to phone dialing system enables both computer aided terminal interviewing (local servers systems) and Internet based interviewing terminal systems to work independently of an external phone line, thus reducing costs and time for interviewing conducted with these systems. It should be understood that it is within the scope of the present invention to use any technique in which an Internet screen or web-based application (java, Cold Fusion, etc.) is utilized to select a phone number, dial that number and present an interviewer or telemarketer or other phone operator with a screen with questions and scripts and prompts for responses and the voice data and conversation are held through the same line as the data transmitted regarding the call and any other information.

Referencing FIG. 8, this alternative embodiment of the invention varies from the embodiment in FIG. 1 in that an Internet to phone dialing web server (800) is included. This Internet to phone dialer (800) replaces the dialer server (30). The Internet to phone dialer (800) has the capability of dialing a telephone number over the Internet, so that the toll charges incurred from making the phone call are minimized and a separate phone line is not necessary. Currently, with the use of a DSL line, a telephone can be operated as an independent apparatus which is external to the computer while someone is on the Internet. This is one accepted method of including an autodialing or manual dialing system to the present invention and allowing an interviewer to make calls while seated in front of their computer terminal.

The present invention calls for a new way of creating this opportunity for interviewing, wherein existing technologies which allow for only one line to be used are incorporated, so that the phone number is dialed and a voice connection is made using the Internet itself, internally and with the use of a headset or microphone attached to the computer. Embodiments of the present invention using existing technologies which accomplish this function, e.g. “www.dialpad.com” type of web-phone apparatuses, are also within the scope of the invention when linked to an interviewing system used for research over the Internet.

The Internet to phone server (800) has the same capabilities as the dialer server (30) in terms of the determination of the initial call disposition (determination of a live vs. dead line, etc.) as referenced in FIG. 4 in step 414. The Internet to phone server (800) will have the capability additionally of hosting the sample generation server (10) and the sample database server (20) within one integrated computer system responsible for the entire process of telephone sampling of a population.

FIG. 9 shows an embodiment of the invention having a system known herein as Internet based interviewing terminal (IBIT), wherein the computer aided terminal interviewing system (CATI) is replaced by an integrated computer system which would be responsible for the entire process of telephone sampling (as referenced in the FIG. 8 description). The difference between a CATI system and its corresponding terminals is that a CATI system requires a computer server and a local area network which serves as a hub for the various CATI Terminals (as referenced in FIG. 1, etc.), while the IBIT system is administered through the Internet, allowing any computer with Internet access to serve as an interviewing station or terminal.

This alternative embodiment of the present invention is unique and widely applicable. In fact, this embodiment can be used in any situation utilizing outbound or inbound phone calling systems which are currently client server or LAN based systems.

It should be noted that the alternative embodiment of the present invention which includes the IBIT system seeks to bring all functionalities of the sampling, recruiting and online data collection systems onto the Internet, thereby reducing the cost of creating the present invention by relying on modules that are hosted on fewer servers, and also using the advantages of the Internet (24 hour real time access, access from any terminal with Internet capabilities).

Referencing FIG. 9, the components are shown for an embodiment of the present invention with Internet based interviewing terminal functionality, replacing the CATI system server (40) and integrating all recruiting functions onto a server (900). Interviewing website server (900) is a server which hosts all recruiting functions necessary to invite selected persons Aₒ to the website (200) to do a survey, including scripts for the phone interview (41) and call back module (60) which are referenced above in FIG. 1. Additionally, the website server (900) hosts the recruiter database (920), a set of data concerning the names, log in passwords, active or inactive status, personal or employment information and other data relating to the individuals who will be making the phone calls, namely telephone recruiters (901).

The website driver (950) is also hosted on server (900). This driver is similar to website driver (250) in that it is a set of instructions for building HTML pages which will be accessed over the Internet by individuals, in this instance the telephone recruiters (901) who will be logging in to conduct phone calls at the direction of the Internet based interviewing terminal system. The website driver (950) builds interviewing website (951) at a predesignated IP address. This website (951) allows for the recruiters (901) to log on and begin making phone calls to preselected individuals and also provides the visual instructions, including the script (41) to be read and any pre-screening questions q which are to be asked of the sample members A and recorded to the survey results database (70).

The process for accomplishing the present invention in alternative embodiment incorporating the Internet based interviewing terminal is as follows: sample generation server (10) writes a sample to the sample database server (20) and the sample control module (210) directs the website server (900) to initiate the website driver (250), thereby creating a log in screen at the IP address for the website (951). The interviewer (901) logs in at the client node (984) and goes on the web to the IP address where the website (951) is hosted and enters a valid log in identifier as confirmed through the recruiter database (920). The sample control module directs the sample database (20) to select a phone number as per the procedures outlined in the description of the sampling system (FIG. 4). The phone number is passed to the website server (900) and the website driver (951) creates a screen which includes the script for the phone interview (41), information about sample members A which is necessary for the phone interview (phone, name, position, company), and any pre-screening questions q necessary for the phone call. In the instance where a dialer server (30) is utilized, the telephone recruiter (901) either manually dials the phone number on a separate phone line, or an autodialer is connected externally to the computer and the autodialer dials the phone number on a separate line, and a phone is used by the interviewer (901) to speak to the sample member A. In the instance where an Internet Dialer (800) is used, the phone call is placed within the computer system (over the Internet, as described in FIG. 8) and therefore a headset and microphone connected to the computer are used by the interviewer (901) and no external phone is necessary.

Once the phone call has been placed by either dialer server (30) or (800), the interviewer reads the script (41) and asks appropriate questions q. Responses to those questions prescreening information) are input to the computer by the interviewer, and recorded to the survey results database (70) by the website server (900). The process ends when the sample control module (210) detects that the survey has been completed and no longer requests a phone number from the sample database server (20) or in the event of the log off by the recruiter.

Sampling Methods

The goal of conducting a survey is to create a set of data which are as likely as possible to reflect the views of the population, had every member of the population been surveyed. In order for this goal to be achieved, a key condition must be met: That a process known as “random sampling” be utilized to derive the members which are included in the final set of survey data.

As described above in the Definition of Terms, a scientific sample must be derived from the population, and then the desired sample members must be systematically recruited to ensure that a representative set of data results in the survey. The keys to this being true are that an “nth select” is used to derive the sample and that the initial sample points identified in the “nth select” be considered the “best-fit” survey targets, and that every effort be made to get highest-positioned sample member from the sample in every sample point.

There are two basic opportunities for creating samples for telephone based survey sampling and recruiting: list sampling and RDD sampling. In both cases, the conditions outlined above regarding the “nth select” and the “best-fit” sample members are met.

To conduct list sampling, a list of the population is obtained. For example, phone lists are available from clients, list brokers or other sources (and are considerably more available and reliable then e-mail lists) as one skilled in the art would readily note. This phone list is first divided into chunks or groups of respondents; most typically they are arranged into groups according to geographical location. The geographic location of an individual member of the population is easily identified by the first 3 digits of their telephone number, or exchange, and can more closely be approximated if the actual street address or zip code or other information is also attached to the data for that individual.

Each specific chunk of respondents is then alphabetized if the names of the individual members of the population are available (alpha order is random order). Thus, there now exists a list of the population with individual groups of respondents listed alphabetically and grouped according to geographic representation within the population. An nth select is performed on the chunks within the list of the population until a representative sample including sample points and clusters in proportion to the geographic representation of the chunks with enough sample members (a=y in each cluster) to complete the survey is obtained.

To conduct RDD sampling if a list of the population cannot be obtained, random digit dial replicants of a geographic area including all households included in the population are used. A replicant is similar to the clusters generated from the lists of the population as described above in the list sampling example, and are considered interchangeable for the purposes herein. These RDD clusters are a list of phone numbers grouped together according to the first 3 digit exchange. These lists are created by telephone companies such as Verizon or QWest. The phone numbers which appear on this list are created by identifying the areas to be included in the sample to be surveyed of the population. The 3 digit exchanges of the telephone households in that area are imported to a computer server, which utilizes a standard random digit generator to attach a 4 digit randomly generated number to the 3 digit exchange. Thus, instead of writing the record of the member selected for that sample member A within cluster N, the RDD process writes a random digit within a given geographic area. It is important to note that this method allows for unlisted numbers to be included in the sample, as well as dead or otherwise non-functional telephone numbers as well. These replicants are ordered with the number of replicants equal to the number of total completed interviews in proportion to the geographic representation within the population of each 3-digit exchange and the number of telephone numbers within each replicant equal to the Y which has been determined for the individual project.

In one embodiment, the present invention is an apparatus which creates a linkage between systems and apparatuses relating to a method for Internet sampling for survey research or other purposes involving interviewing conducted on the World Wide Web. In one particular embodiment, method and related system of the present invention, comprises the steps of:

a) a population to be surveyed is identified, with list sampling being used in the case where a list of phone numbers is available and the purchase of replicants of randomly generated phone numbers in the case where a list of phone numbers is not available;

b) a sample database is generated by selecting numbers from the population in a systematic way known as an “nth select”; the “nth select” is the first requirement for meeting random sampling requirements (the industry standard for scientific research) to generate the survey responses;

c) the sample database is imported to a computer that is itself or is directly linked to a dialer or Internet to phone dialer capable of dialing telephone numbers or directing a recruiter to manually dial a phone number;

d) a loop is executed which ensures that the best-fit sample members (those selected earliest in the passes through the population in creating the samples, thus meeting the second requirement for ensuring a random sample) are those who are invited to and complete the survey;

e) telephone calls are made to the best-fit sample member within each cluster to invite them to visit a website and complete the survey;

f) each individual who qualifies for and agrees to participate in the survey is invited to a website to take the survey;

g) the individual is either assigned or volunteers a password which is recorded as part of the individual's data record;

h) a website is provided where individuals can log on and enter their password. If the password is valid within the given parameters (time frame, for example), they are allowed to continue; invalid passwords are rejected;

i) the website displays a set of instructions to the individual at their terminal for taking the survey;

j) a series of questions come on their terminal requesting mouse or keyboard inputs and a series of questions follows the logic and order requirements of the particular survey;

k) a given questionnaire is finished by an individual within a particular cluster and that cluster is considered “completed” and is closed; and

l) the loop is completed when all clusters are complete and the necessary number of interviews are therefore finished.

Automation may be used wherein monitoring of the status of the individual between the sampling and recruiting system and the online data collection system generates phone calls to encourage participation, first when an individual has not visited the website within a given time frame after agreeing to participate, and secondly, if an individual begins a survey and does not complete. In this instance, individuals pick up where they left off upon revisiting the website. Scheduled call-backs are also possible, with potential respondents requesting follow-up calls, as well as automatically delivered e-mail messages to potential respondents to encourage participation.

In one embodiment, an apparatus is provided which connects the above stated functionalities and creates a novel system and approach for monitoring, reporting and constantly checking for statuses and data inputs between the systems described above. Specifically, the apparatus sample control module links the sampling systems (involving the derivation of the scientific sample from the population) and the recruiting systems (involving the selection of scientifically selected phone numbers and the prompting of a phone call conversation, including the recording of data, wherein desired sample members are invited to the online survey website) and the online data collection systems (the online survey website, including a log-in page which is monitored by the apparatus to prompt the recruiting system to place various types of call-backs, and also including the necessary pages with questions and responses used for collecting survey data, and also including any reporting and outputting of the data).

While various embodiments of the present invention have been described in detail, it will be apparent that further modifications and adaptations of the invention will occur to those skilled in the art. It is to be expressly understood that such modifications and adaptations are within the spirit and scope of the present invention.

What is claimed is:

1. A method for performing an internet survey comprising:
(A) deriving a scientifically representative set of respondents from a scientifically derived sample;
(b) contacting said respondents;
(c) collecting responses from said respondents on a website wherein said respondents complete a survey on the website; and
(d) using telephone phone probability sampling standards to conduct said survey.

2. The method as set forth in claim 1, wherein a sample control module is used to operate as a link between at least one Internet web server and a telephonic technology to ensure that scientific sampling standards are being achieved.

3. The method as set forth in claim 1, wherein an Internet-based dialer dials a phone number over the Internet from a given database of telephone numbers, establishes an initial call disposition, and connect a live person with a telemarketer or telephone survey interviewer.

4. The method as set forth in claim 1, wherein said step of collecting comprises providing a graphic interface which appears on said website for the purposes of collecting responses to questions requiring answers selected from choices including essentially: a) do you strongly agree, b) somewhat agree, c) somewhat disagree, and d) strongly disagree, said answers expressed as a predetermined numerical value;
presenting a question to said respondent, with said choices presented spaced along a continuous line with markers indicating said response choices along the line at evenly spaced points; and
having said respondents utilize a mouse-click or a keyboard stroke to indicate their individual response to the question on said line at a desired point.

5. The method as set forth in claim 1, wherein said respondents are selected through sampling of phone numbers, telephone recruiting and screening, website status checks and online data collection.

6. The apparatus as set forth in claim 1, wherein the recruiting and outbound or inbound phone calling of the present invention is conducted through an Internet Based Terminal Interviewing system is created over the World Wide Web in which supervisors and administrators can set up and maintain sampling and recruiting and script and database and any other functions involved in outbound or inbound calling over the Internet; with employees or recruiters or interviewers or others who make the phone calls for such calling also accessing all functions necessary for the recruiting functionalities over the Internet, including logging in to work, having a phone number dialed and being given a script and questions to be read to an individual, and the recording of the responses from that individual, and thus allowing any individual with an Internet terminal to conduct an interview and gather data provided they have Internet access, and no longer requiring Local Area Network or client server based applications.

7. The apparatus as set forth in claim 6 wherein one communications line is used for both the data line transmitting the data over the Internet being used in the Terminal interviewing system noted above and also is used for the Voice data which is transmitted for the phone call conversation, allowing a recruiter to work at a computer station with a headset and have a phone call placed over the Internet to a pre-selected individual without needing a phone line separate from the computer.
